(19) United States
(12) Patent Application Publication
(10) Pub. No.: US 2009/0006335 A1
(43) Pub. Date: Jan. 1, 2009

(54) System And Method For Distributing Multimedia Information

(75) Inventor: Steven Todd Prager, Coral Springs, FL (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: VideoKeyhole.com, Inc., Boca Raton, FL (US)

(21) Appl. No.: 11/924,325

(22) Filed: Oct. 25, 2007

Related U.S. Application Data
(60) Provisional application No. 60/863,027, filed on Oct. 26, 2006.

(51) Int. Cl. G06F 7/06; G06F 15/16; G06F 17/30

(52) U.S. Cl. 707/3; 709/202; 707/104.1; 707/E17.014; 707/E17.044

(57) ABSTRACT

A system for distributing multimedia information includes a user interface module. The user interface module is configured to receive an upload of multimedia information from a user. The user interface module is also configured to receive at least one multimedia information distribution indication from the user for selecting at least one remote site to which to distribute the multimedia information. The system includes a multimedia information distribution module in communication with the user interface module. The multimedia information distribution module is configured to distribute the multimedia information to the at least one remote site in accordance with the multimedia information distribution indication.

### PRIORITY

This application claims the benefit under 35 U.S.C. § 119(e) of U.S. Provisional Application Ser. No. 60/863,027, filed Oct. 26, 2006, entire contents of which are expressly incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

### Field of the Invention

The present invention relates to information distribution systems. More particularly, the present invention relates to a system and method for distributing multimedia information.

### SUMMARY OF THE INVENTION

It is therefore a general aspect of the invention to provide a TBD that will obviate or minimize problems of the type previously described.

According to a first aspect of the present invention, a system for distributing multimedia information is provided, comprising: a user interface module, wherein the user interface module is configured to receive an upload of multimedia information from a user; and wherein the user interface module is configured to receive at least one multimedia information distribution indication from the user for selecting at least one remote site to which to distribute the multimedia information; and a multimedia information distribution module in communication with the user interface module, wherein the multimedia information distribution module is configured to distribute the multimedia information to the at least one remote site in accordance with the multimedia information distribution indication.

According to the first aspect of the present invention, the system further comprises a multimedia information search module in communication with the multimedia information management module, and wherein the multimedia information search module is configured to search for multimedia information uploaded by the user.

According to the first aspect of the present invention, the multimedia information search module is further configured to search for multimedia information located on the at least one remote site.

According to the first aspect of the present invention, the multimedia information search module further comprises a multimedia information management module in communication with the multimedia information distribution module, wherein the multimedia information management module is configured manage the multimedia information and multimedia characteristic information associated with the multimedia information.

According to the first aspect of the present invention, the multimedia information search module further comprises a database module in communication with the multimedia information distribution module, wherein the database module is configured to store at least one of the multimedia information and user characteristic information.

According to the first aspect of the present invention, the multimedia information comprises video multimedia information, audio multimedia information, and/or photographic multimedia information.

According to the first aspect of the present invention, the multimedia information search module is configured to interface to the at least one remote site, and to edit multimedia information in accordance with commands received from the user via the user interface module.

According to the first aspect of the present invention, the multimedia information search module is configured to edit multimedia characteristic information in accordance with commands received from the user via the user interface module, and is further configured to delete multimedia information from the at least one remote site in accordance with instructions received from the user via the user interface module.

Further still according to the first aspect of the present invention, the user interface module is configured to display a graphical user interface to the user for interacting with the system.

According to the first aspect of the present invention, the multimedia information search module comprises a communication module, wherein the communication module is configured to communicate information between the system and the at least one remote site.

According to a second aspect of the present invention, a system for distributing multimedia information is provided comprising a system access engine, wherein the system access engine is configured to display a graphical user interface to the user for interacting with the system, wherein the system access engine is configured to receive an upload of multimedia information from a user; and wherein the system access engine is configured to receive a plurality of multimedia information distribution selections from the user for selecting a plurality of remote sites to which to distribute the multimedia information; and a distribution engine in communication with the system access engine, wherein the distribution engine is configured to distribute the multimedia information to the plurality of remote sites in accordance with the multimedia information distribution selections.

According to a third aspect of the present invention, a method for distributing multimedia information is provided comprising a.) receiving an upload of multimedia information from a user; b.) receiving at least one multimedia information distribution indication from the user to select at least one remote site to which to distribute the multimedia information; and c.) distributing the multimedia information to the at least one remote site in accordance with the multimedia information distribution indication.

According to a fourth aspect of the present invention, a computer-readable medium containing a computer program for distributing multimedia information is provided, wherein the computer program performs the steps of: a.) receiving a first indication of an upload of multimedia information from a user; b.) receiving a second indication of least one multimedia information distribution selection from the user to select at least one remote site to which to distribute the multimedia information; and c.) generating a signal to cause a distribution of the multimedia information to the at least one remote site in accordance with the multimedia information distribution indication.

According to a fifth aspect of the present invention, a system for distributing multimedia information is provided comprising displaying structure for displaying multimedia information, wherein the multimedia information displaying structure is configured to receive an upload of multimedia information from a user; and wherein the multimedia information displaying structure is configured to receive at least one multimedia information distribution indication from the user for selecting at least one remote site to which to distribute the multimedia information; and distributing structure for distributing multimedia information in communication with the multimedia information displaying module, wherein the multimedia information distributing structure is configured to distribute the multimedia information to the at least one remote site in accordance with the multimedia information distribution indications.

### BRIEF DESCRIPTION OF THE DRAWINGS

Objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system 100 for distributing multimedia information in accordance with an exemplary embodiment of the present invention.

FIG. 2 is a flowchart illustrating steps for distributing multimedia information in accordance with an exemplary embodiment of the present invention.

FIG. 3 illustrates a physical design of a network for distributing multimedia information according to an exemplary embodiment of the present invention.

FIG. 4 is a block diagram illustrating several functional actions that a system access subsystem program can perform for different users in accessing the system according to an embodiment of the present invention.

FIG. 5 illustrates a login operation activity diagram for use with the system and method for distributing multimedia information according to an embodiment of the present invention.

FIG. 6 illustrates an activity diagram for creating an account for use with the system and method according to an embodiment of the present invention.

FIG. 7 illustrates a screen shot of a home page of a website used by the system and method for distributing multimedia information according to an embodiment of the present invention.

FIG. 8 illustrates a screen shot of a registration page of a website used by the system and method for distributing multimedia information according to an embodiment of the present invention.

FIG. 9 illustrates a screen shot of a login page of a website used by the system and method for distributing multimedia information according to an embodiment of the present invention.

FIG. 10 illustrates a sequence diagram representing several activities of system 100 and unauthenticated users 3 when becoming authenticated according to an embodiment of the present invention.

FIG. 11 illustrates an activity diagram for managing an account for use with the system and method according to an embodiment of the present invention.

FIG. 12 illustrates a screen shot of a manage account page of a website used by the system and method for distributing multimedia information according to an embodiment of the present invention.

FIG. 13 illustrates a sequence diagram representing several activities of system 100 and authenticated users 4 when managing their account according to an embodiment of the present invention.

FIG. 14 is a block diagram illustrating several functional actions that a manage video subsystem program can perform by users when accessing a system according to an embodiment of the present invention.

FIG. 15 illustrates an activity diagram for uploading videos using the system and method according to an embodiment of the present invention.

FIG. 16 illustrates a screen shot of a home page after a user has selected the Video Manager button, located along an upper tool bar of the home page of a website used by the system and method for distributing multimedia information according to an embodiment of the present invention.

FIG. 17 illustrates a screen shot of an distribute video page of a website used by the system and method for distributing multimedia information according to an embodiment of the present invention.

FIG. 18 illustrates a sequence diagram representing several activities performed by the system and method for distributing multimedia information when uploading video to one or more external sites according to an embodiment of the present invention.

FIG. 19 illustrates a screen shot of an upload new video page used by the system and method for distributing multimedia information according to an embodiment of the present invention.

FIG. 20 illustrates an activity diagram for creation of a new video category using the system and method for distributing multimedia information according to an embodiment of the present invention.

FIG. 21 illustrates a screen shot of a create video category page used by the system and method for distributing multimedia information according to an embodiment of the present invention.

FIG. 22 is an activity diagram that illustrates the steps that the system and method for distributing multimedia information perform when editing videos stored within system according to an embodiment of the present invention.

FIG. 23 illustrates a screen shot of an edit video page used by the system and method for distributing multimedia information according to an embodiment of the present invention.

FIG. 24 illustrates a second screen shot of an additional edit video page used by the system and method for distributing multimedia information according to an embodiment of the present invention.

FIG. 25 illustrates a sequence diagram representing several activities by the system and method for distributing multimedia information and authenticated users when uploading updated multimedia information to one or more external sites according to an embodiment of the present invention.

FIG. 26 is an activity diagram that illustrates the steps that the system and method for distributing multimedia information perform when deleting videos stored within system 100 according to an embodiment of the present invention.

FIG. 27 illustrates a screen shot of a delete video page used by the system and method for distributing multimedia information according to an embodiment of the present invention.

FIG. 28 illustrates an additional screen shot of a delete video page used by the system and method for distributing multimedia information according to an embodiment of the present invention.

FIG. 29 illustrates a sequence diagram representing several activities by the system and method for distributing multimedia information and authenticated users when deleting multimedia information from one or more external sites according to an embodiment of the present invention.

FIG. 30 is an activity diagram that illustrates the steps that the system and method for distributing multimedia information perform when editing target sites accessed by system 100 according to an embodiment of the present invention.

FIG. 31 illustrates a screen shot of an edit target site page used by the system and method for distributing multimedia information according to an embodiment of the present invention.

FIG. 32 illustrates a sequence diagram representing several activities by the system and method for distributing multimedia information and authenticated users when editing target sites according to an embodiment of the present invention.

FIG. 33 is an activity diagram that illustrates the steps that the system and method for distributing multimedia information performs when viewing an upload history of videos stored within the system according to an embodiment of the present invention.

FIG. 34 illustrates a screen shot of an upload history page used by the system and method for distributing multimedia information according to an embodiment of the present invention.

FIG. 35 illustrates a sequence diagram representing several activities by the system and method for distributing multimedia information and authenticated users when viewing an upload history according to an embodiment of the present invention.

FIG. 36 is an activity diagram that illustrates the steps that the system and method for distributing multimedia information performs when viewing a distribution status of videos stored within system according to an embodiment of the present invention.

FIG. 37 illustrates a screen shot of a view distribution status page used by the system and method for distributing multimedia information according to an embodiment of the present invention.

FIG. 38 illustrates a sequence diagram representing several activities by the system and method for distributing multimedia information and authenticated users when viewing a distribution status according to an embodiment of the present invention.

FIG. 39 illustrates a screen shot of a view distribution status results page used by the system and method for distributing multimedia information according to an embodiment of the present invention.

FIG. 40 illustrates a top-level representation of a distribution engine software subsystem that enables a database of the system and external sites used by the system to interface with each other according to an embodiment of the present invention.

FIG. 41 is an activity diagram that illustrates the steps that the system and method for distributing multimedia information performs when performing a post add video process according to an embodiment of the present invention.

FIG. 42 illustrates a sequence diagram representing several activities by the system and method for distributing multimedia information and authenticated users when performing the post add video process as described in reference to FIG. 41 according to an embodiment of the present invention.

FIG. 43 is an activity diagram that illustrates the steps that the system and method for distributing multimedia information performs when performing a post remove video process according to an embodiment of the present invention.

FIG. 44 illustrates a sequence diagram representing several activities by the system and method for distributing multimedia information and authenticated users when performing the post remove video process as described in reference to FIG. 43 according to an embodiment of the present invention.

FIG. 45 is an activity diagram that illustrates the steps that the system and method for distributing multimedia information performs when performing a post edit video process according to an embodiment of the present invention.

FIG. 46 illustrates a sequence diagram representing several activities by the system and method for distributing multimedia information and authenticated users when performing the post edit video process as described in reference to FIG. 45 according to an embodiment of the present invention.

FIG. 47 is an activity diagram that illustrates the steps that the system and method for distributing multimedia information performs when sending a video to a user's friend according to an embodiment of the present invention.

FIG. 48 illustrates a sequence diagram representing several activities by the system and method for distributing multimedia information when sending the video to a user's friend as described in reference to FIG. 47 according to an embodiment of the present invention.

FIG. 49 illustrates a screen shot of a video search page used by the system and method for distributing multimedia information according to an embodiment of the present invention.

FIG. 50 illustrates a screen shot of a video search results page used by the system and method for distributing multimedia information according to an embodiment of the present invention.

FIG. 51 illustrates a screen shot of a selected video page following use of the video search page used by the system and method for distributing multimedia information according to an embodiment of the present invention.

FIG. 52 illustrates a screen shot of a video vault page used by the system and method for distributing multimedia information according to an embodiment of the present invention.

FIG. 53 illustrates a screen shot of an email address entry screen for forwarding one or more videos to a friend as used by the system and method for distributing multimedia information according to an embodiment of the present invention.

FIG. 54 illustrates a screen shot of sub-window used to delete a category of videos as used by the system and method for distributing multimedia information according to an embodiment of the present invention.

FIG. 55 illustrates a block diagram of an architecture of a system for distributing multimedia information in accordance with an exemplary embodiment of the present invention.

FIG. 56 illustrates a block diagram of a high level architecture of the system and method for distributing multimedia information according to an embodiment of the present invention.

FIG. 57 illustrates a block diagram of a search service architecture of the system and method for distributing multimedia information according to an embodiment of the present invention.

FIG. 58 illustrates a block diagram of an upload/publish service architecture of the system and method for distributing multimedia information according to an embodiment of the present invention.

FIG. 59 illustrates an application flow chart of the system and method for distributing multimedia information according to an embodiment of the present invention.

FIG. 60 illustrates a search service flowchart of the system and method for distributing multimedia information according to an embodiment of the present invention.

FIG. 61A is a sequence diagram illustrating various steps in performing a check/retrieve search queue from a database used in the system and method for distributing multimedia information according to an embodiment of the present invention.

FIG. 61B is a sequence diagram illustrating various steps in sending a request to a process manager used in the system and method for distributing multimedia information according to an embodiment of the present invention.

FIG. 61C is a sequence diagram illustrating various steps in parsing request data and sending it to an HTTP manager used in the system and method for distributing multimedia information according to an embodiment of the present invention.

FIG. 61D is a sequence diagram illustrating various steps in creating multiple requests and receiving data from external web sites used in the system and method for distributing multimedia information according to an embodiment of the present invention.

FIG. 61E is a sequence diagram illustrating various steps in which a response parser parses data and updates a database used in the system and method for distributing multimedia information according to an embodiment of the present invention.

FIG. 61F is a sequence diagram illustrating various steps in which an application checks a status of a request as used in the system and method for distributing multimedia information according to an embodiment of the present invention.

FIG. 61G is a sequence diagram illustrating various steps in retrieving data from a database as used in the system and method for distributing multimedia information according to an embodiment of the present invention.

FIG. 62A is a sequence diagram illustrating various steps in which an upload process checks/retrieves an uploads queue used in the system and method for distributing multimedia information according to an embodiment of the present invention.

FIG. 62B is a sequence diagram illustrating various steps in performing an upload to the system and method for distributing multimedia information according to an embodiment of the present invention.

FIG. 62C is a sequence diagram illustrating various steps in which an upload manager creates instances of upload engines as used in the system and method for distributing multimedia information according to an embodiment of the present invention.

FIG. 62D is a sequence diagram illustrating various steps in which an upload manager updates a status of an upload as used in the system and method for distributing multimedia information according to an embodiment of the present invention.

### DETAILED DESCRIPTION OF THE PREFERRED EMBODIMENTS

### I. Overview of System and Method for Distributing Multimedia Information.

Exemplary embodiments of the present invention are directed to a system and method for distributing multimedia information. Exemplary embodiments of the present invention can be used in conjunction with any device, system or process for distributing multimedia information to one or more remote sites, e.g., over a network. For example, exemplary embodiments of the present invention can be used to upload a video file from the user to the system, and the system can then distribute the video to a plurality of websites on behalf of the user. In such a manner, the user is not required to manually upload the video file to each desired site, thereby providing a savings in time and expense to the user.

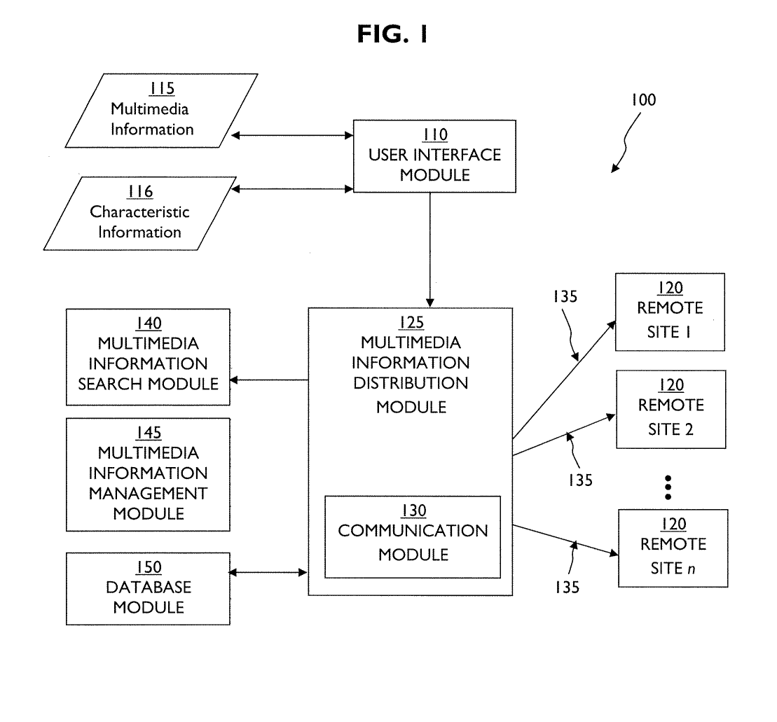

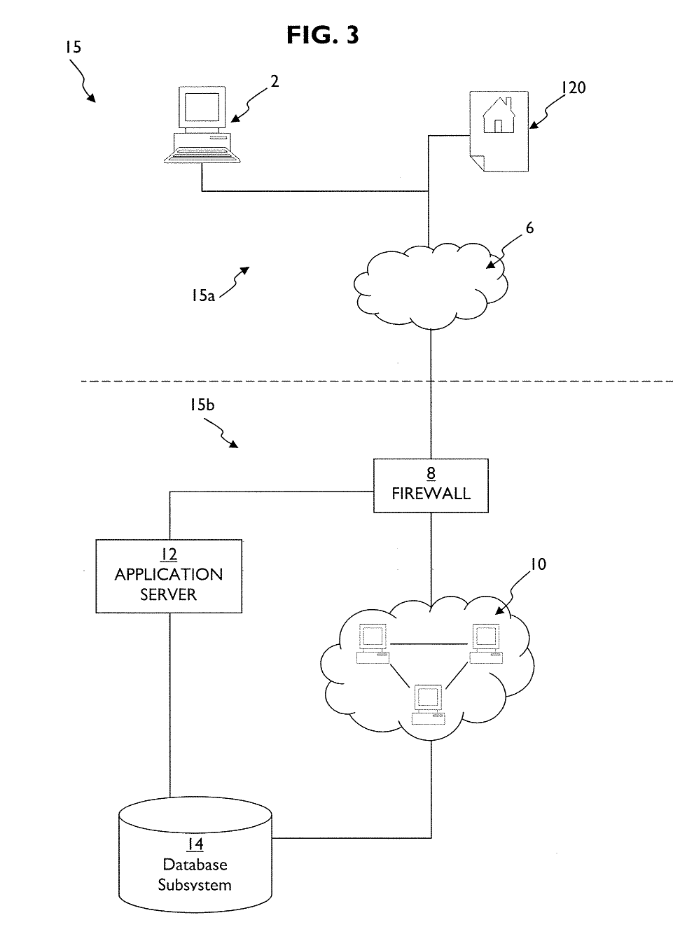

FIG. 1 is a block diagram illustrating a system 100 for distributing multimedia information, in accordance with an exemplary embodiment of the present invention. The system 100 includes a user interface module 110, multimedia information distribution module 125, communication module 130, database module 150, multimedia information management module 145, and at least one or more remote sites 120-120n. FIG. 3 illustrates a physical design of a network 15 for distributing multimedia information according to an exemplary embodiment of the present invention. Network 15 includes, by way of example only, a client or end user 2, an external site (remote) 120, and world wide web 6. As those of ordinary skill in the art of the present invention can appreciate, client 2, external site (remote) 120 and the other components, to be named below, can communicate not only through the world wide web, which is shown as an illustrative example, and not in a limiting manner, but also via local area networks (LANs), wide are networks (WANs), other private/public intranets, and these can also include, for example, wired, wireless and/or combinations of wired and wireless communications systems. Network 15 can be a combination of RF wireless communication systems (satellite, line of sight microwave frequency, or over-the-horizon radio frequency, or acoustic, among other types) and wired communication systems (cable, and fiber optic, among other types).

Referring to FIG. 3, first network portion 15a can represent a public or private portion of network 15, and second network portion 15b represents that part of the network substantially under control of the operators of the multimedia distribution system according to an embodiment of the present invention. Network 15 further comprises firewall 8, WWW web farm 10, application server 12, and database subsystem 14. Database subsystem 14 need not be a physically separate component, but can be integrated within application server 12, as those of ordinary skill in the art can appreciate. The same applies to firewall 8, and www web farm 10; they can all be separate components, or grouped together in any combination, according to various embodiments of the present invention. Operation of each of the components of network 15a and 15b are known to those of ordinary skill in the art of the present invention. Therefore, a detailed discussion of each of these items shall be omitted for the purposes of brevity and clarity.

### II. System for Distributing Multimedia Information

### A. User Interface Module 110

### 1. Description

The user interface module 110 is configured to receive user characteristic information 116 from the user. User characteristic information includes information such as the user's name, address, e-mail address, login information, password, and the like. System 100 can elicit such information from the user, e.g., when the user is creating an account with the system and when the user wishes to access the system 100. According to exemplary embodiments of the present invention, the system and method of the present invention can be implemented on the Internet, through a user's personal or other computer. As such, several exemplary screen shots illustrate various steps in the method of uploading and distributing multimedia information, as well as registering and accessing personal account information, among other items. Several of these screen shots have been included and discussed herein, including those that pertain to creating an account, which are discussed infra. It should be understood, embodiments of the present invention may be used screen shots that include additional information or arranged using different layouts.

The user interface module 110 is also configured to receive an upload of multimedia information 115 from a user. The user interface module 110 is also further configured to receive at least one multimedia information distribution indication or selection from the user for selecting one or more external or remote sites 120 (e.g., IFILM, YouTube, ClipPix, Google Video, Yahoo, msn, jumpcut, myspace.com, and vmix, among others) to which to distribute the multimedia information 115. The remote sites 120 can comprise, for example, websites or other network locations to which the user desires to distribute the multimedia information 115. Any suitable number of remote sites 120 can be indicated or otherwise selected by the user (e.g., remote site 1, remote site 2, . . . , remote site N).

According to an exemplary embodiment, user interface module 110 is further configured to display graphical and/or textual information to the user. For example, the user interface module 110 can be configured to display a webpage having a plurality of fields where the user can input user characteristic information 116 and when the user wishes to access the system. The user interface module 110 can also be configured to display a selection webpage for selecting the one or more remote sites 120, as well as allow the user to upload the multimedia information 115 to the system 100 (via a suitable information transmission protocol). Additionally, the user interface module 110 can comprise a portal or interface through which the user provides or otherwise enters the multimedia information 115 and other associated information for use by the system 100. In other words, the user interface module 110 can be configured to display a graphical user interface to the user for interacting with the system 100. For example, the user can enter multimedia characteristic information or other metadata relating to, e.g., the categories under which the multimedia information falls. Exemplary categories include comedy, entertainment, politics, music, sports, and the like. Other multimedia characteristic information includes the title of the multimedia information; a brief description of the content of the multimedia information; and tags associated with the multimedia information. As used herein, the term “tags” refers to, for example, key words associated with the video. Thus, for example, if the multimedia information is a Superman trailer, the tags associated with the video could include tags such as “Superman,” “Superman trailer,” “man of steel,” “Lois Lane,” “Barndon Routh,” and “Kate Bosworth.” The tags can, for example, come from a title given to the multimedia information, or from a brief description given of the multimedia information. The multimedia information search module 140, discussed more fully below, would use the multimedia characteristic information to, for example, search for all multimedia information falling under certain categories, and/or having certain tags. The user can enter multimedia characteristic information or other metadata associated with the multimedia information 115 through the portal or interface provided by user interface module 110.

The user interface module 110 can be comprised of any suitable type of user interface capable of displaying graphical and/or textual information to a user and receiving graphical and/or textual information from the user. For example, the user interface module 110 can be configured to display a graphical user interface through a suitable Web browser (e.g., Internet Explorer, Netscape, Firefox, Safari, Opera, or any other suitable Web browser) on any appropriate type of display, such as a computer monitor or other display device (e.g., a personal digital assistant (PDA), a suitable cellular phone, or a like portable display).

### 2. Use Cases For Manage Videos Subsystem

Several use cases shall be described herein in regard to the system, method and architecture of the multimedia information distribution system and method according to exemplary embodiments of the present invention. In order to more fully appreciate the use cases, and to illustrate their relationship with the system and method according to the embodiments of the present invention, several drawings are presented and discussed below. According to a preferred embodiment of the present invention, many of the uses cases are discussed in reference to a particular module; the module therefore contains the software programs that implements all or a majority of the functionality that the use case offers to system 100 and its users. As those of ordinary skill in the art of the present invention can appreciate, substantially all of the use cases can be implemented in other or several other different modules than the ones to which this discussion assigns them. In other words, according to various exemplary embodiments of the present invention, the use cases can reside in any one module, or any combination of modules, and not necessarily the ones to which they are currently assigned.

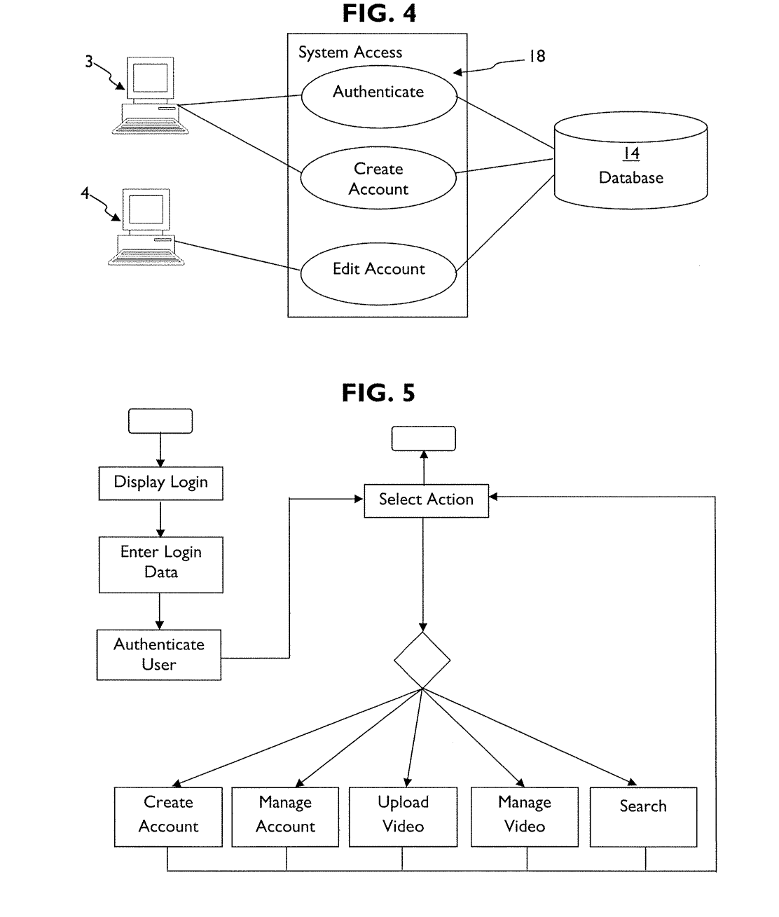

FIG. 4 illustrates a top-level representation of a system access software subsystem that enables users to access the system according to an embodiment of the present invention.

As FIG. 4 illustrates, there can be at least two types of users of the system 100 and method 200 according to an embodiment of the present invention: an anonymous user 3, and authenticated user 4. As those of ordinary skill in the art of the present invention can appreciate, certain portions of system 100 and method 200 will only be available and/or applicable to authenticated users 4, while certain portions of system 100 and method 200 will only be applicable to anonymous users 3. According to exemplary embodiments of the present invention, system access subsystem is software that manages user data and authenticates users. System access subsystem software can, according to a preferred embodiment of the present invention, reside in user interface module 110. As those of ordinary skill in the art of the present invention can appreciate, however, system access subsystem software can reside in a different module, or combination of modules, and still operate as described herein.

In FIG. 4, system access box 18 refers to those operations that users 2, including anonymous users 3 and authenticated uses 4, can perform to gain access to the overall system and method of the present invention. Once access is obtained, account information can be created and stored in database 14, or accessed and modified, as discussed infra.

Anonymous users 3 can create accounts, and provide authentication information in order to create the account. Once authenticated, an anonymous user 3 becomes an authenticated user 4 that can utilize system 100 and method 200 of the present invention. Authenticated users 4 can edit account information that is stored on database 14. The manner in which users 2 access system 100 and method 200 of the present invention is illustrated in several exemplary screen shots, discussed infra, that show how accounts are created and edited.

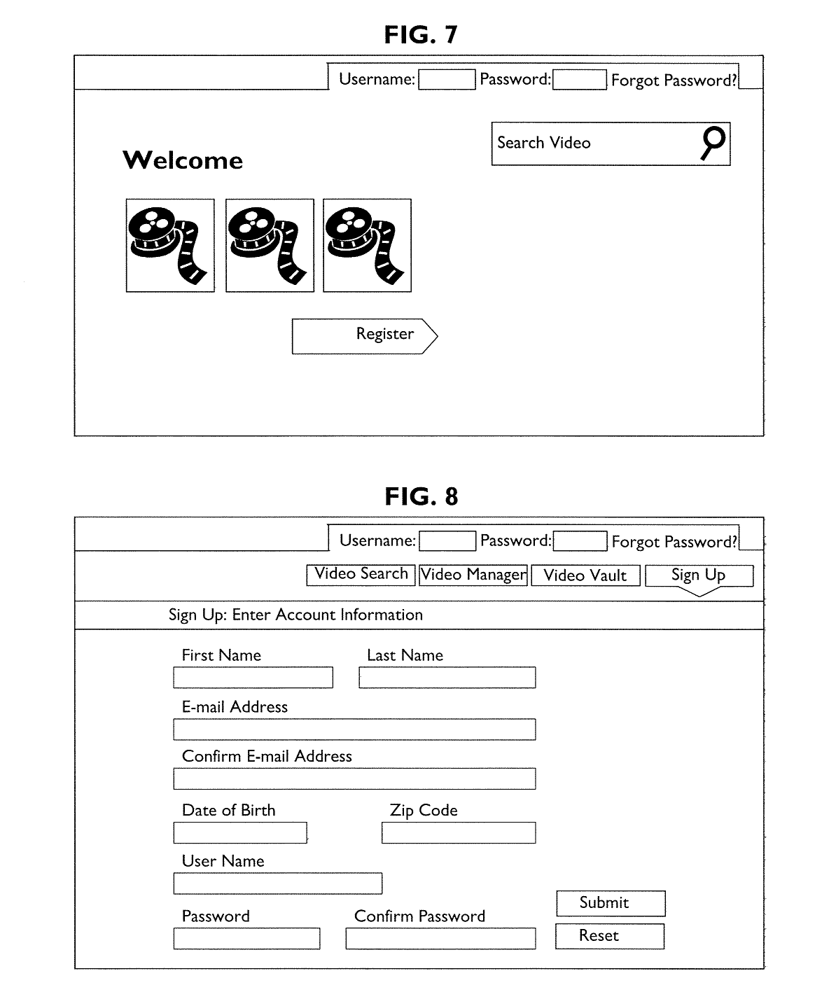

FIG. 5 illustrates a login operation activity diagram for use with the system and method for distributing multimedia information according to an embodiment of the present invention. The activities that occur during login occur using a system access subsystem, which, according to an exemplary embodiment of the present invention, can be software that manages user data and authenticates users. The system access subsystem resides primarily within user interface module 110 according to a preferred embodiment of the present invention, though, as one of ordinary skill in the art of the present invention can appreciate, the system access subsystem software can reside in another, or more than one modules, as described herein. The login activity diagram shown in FIG. 5 illustrates substantially all of the major operations that occurs within the system for distributing multimedia information according to an embodiment of the present invention: login, creating an account; managing an account; uploading video; managing videos; and searching for videos. Each of these major system operations will be discussed infra in reference to FIG. 5. Login operations occur within user interface module 110, and some of the operations, such as creating an account, apply only to anonymous users 3. When an anonymous user 3 accesses system 100, the screen shots as shown in FIGS. 7-9 are displayed. The anonymous user 3 then enters certain required login data, for example, including name, address, date of birth, among other types. Once the required login data is entered, the anonymous user 3 submits the login data form to the system 100. System 100 then authenticates the anonymous user 3 by providing a token to the anonymous user's computer. From thereon the anonymous user can create an account, manage an account (once created), upload video, manage videos and/or search for video. A timer, not shown, will logout the authenticate anonymous user 3 if no action is taken for a certain period of time.

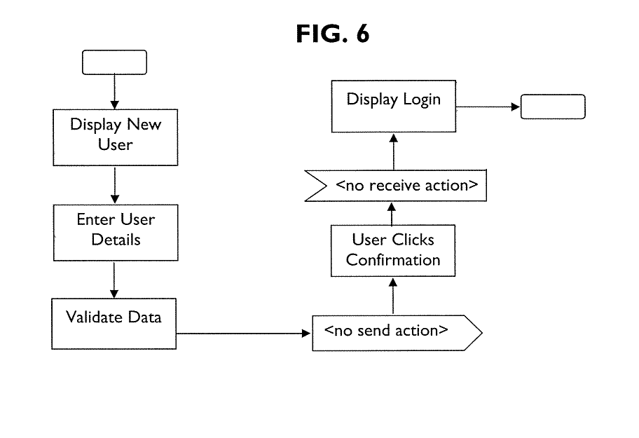

FIG. 6 illustrates an activity diagram for creating an account for use with the system and method according to an embodiment of the present invention. The phrase “creating and account” and “registering” shall mean substantially the same activity, i.e., becoming a new user of the system and method according to an embodiment of the present invention. As the phrase implies, the use case “create account” applies to anonymous users 3 only. While authenticated anonymous users can access the system 100 and method 200 of the present invention without limitations, it is believed most will want to become an authenticated user 4 whose information does not need to be re-entered each time the user accesses the system 100. FIGS. 7-9 are screen shots that illustrate the images displayed on the user's computer for entering account-creating information. The first activity in the activity diagram is to display the screen in FIG. 7 for a new user. The screen shot illustrated in FIG. 7 is also referred to as a “home page”, commonly encountered by users of the internet. The home page shown in FIG. 7 can also be used by authenticated users 4, as the “username” and “password” fields shown in FIG. 7 indicate. Usernames and passwords are established during the “create account” user case, as shall be described. These operations are well known to those of ordinary skill in the art of the present invention, and so shall only be briefly described for purposes of brevity and clarity.

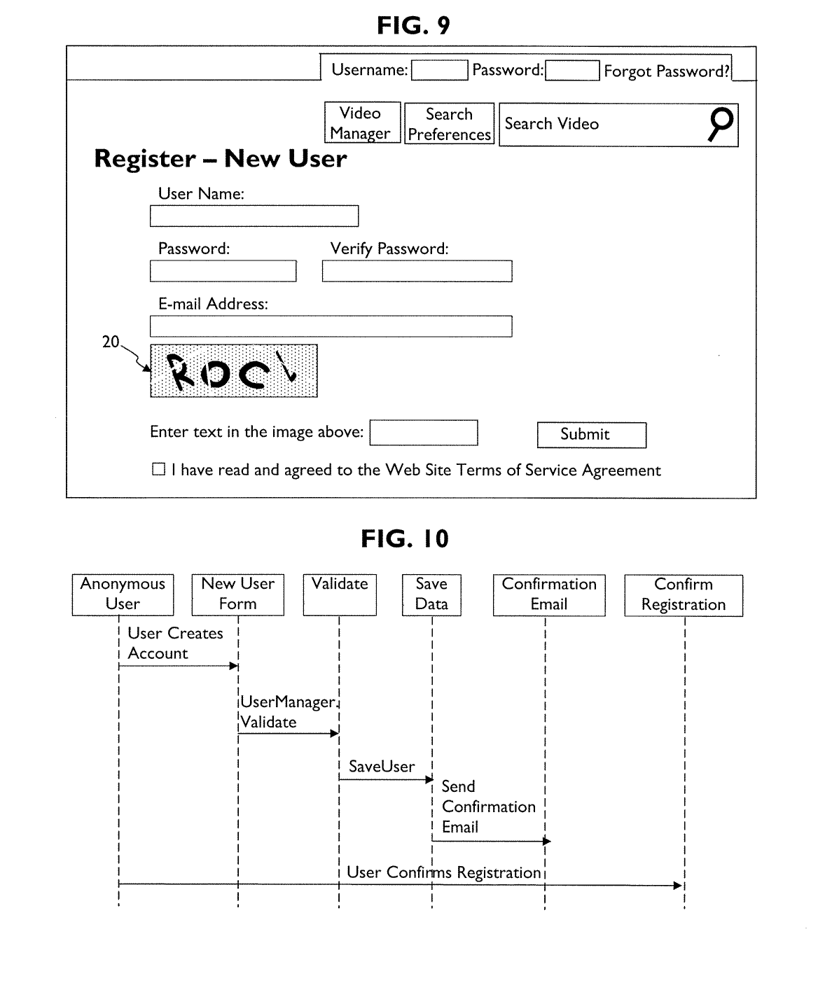

As shown in FIG. 7, anonymous user 3 selects the create account (register) field, thereby selecting the create account operation. Then, user 3 encounters the screen shot shown in FIG. 8, and the user enters user details (the second activity in the activity diagram shown in FIG. 6 “Enter User Details”). In FIG. 8, unauthenticated user 3 will have to enter their first and last name, a user name, password (which needs to be confirmed), their date of birth, and zip code. This information can also be used for security purposes, if, for example, the user forgets their password. As the data is being entered, system 100 validates the data (as shown in the “Validate Data” activity in FIG. 6), and once “submit” is selected by the user (“User Clicks Confirmation” activity in FIG. 6), system 100 creates a user account and displays the login form as shown in the screen shot illustrated in FIG. 9.

Each time an authenticated user 4 desires to use the system and method according to an embodiment of the present invention, he or she will access the appropriate website, of which FIG. 9 is a graphical representation thereof. The user 4 enters their username, password, verifies the password and email address. Security feature 20, the use of which is well known to those of ordinary skill in the art of the present invention, substantially prevents unauthorized entries by individuals and computerized systems from gaining access to system 100. Following input of the security feature character combination, user 4 must certify that they have read and agreed to the terms of the service agreement. User 4 can view the services agreement by following a link. On subsequent visits to system 100 via the website, uses 4 may or may not have to enter their email address, enter their password twice, or encounter security feature 20 and/or read the terms of service agreement. System 100 can monitor such information on cases-by-case basis. In the Create Account Activity Diagram shown in FIG. 6, the steps of displaying the login screen shot (FIG. 9) and entering user data is represented by the “Display Login” activity.

Following successful authentication and login, system 100 can prepare and forward electronic communication (email) to the user's email address provided as described supra. In response, user 4 will confirm receipt of system 100's email by replying to it, which system 100 will accept and verify against previously obtained records. As those of ordinary skill in the art of the present invention can appreciate, the steps described above for authenticating and registering new users of system 100 can be represented by a sequence diagram, as shown in FIG. 10.

FIG. 10 illustrates a sequence diagram representing the several activities of system 100 and unauthenticated users 3 when becoming authenticated according to an embodiment of the present invention (as represented by the Login Activity Diagram shown in FIG. 5). As shown in FIG. 10, an anonymous, or unauthenticated, user 3 creates an account using a new user form (FIG. 8). User 3 places his or her data in a new user form. User interface module 110 then transfer the new user data to a validation portion of system 100, wherein the new user data is validated. A save data segment then saves the data from the new user 3, thereby establishing the new user account, creating an authenticated user 4 from an unauthenticated user 3. A confirmation email is forwarded from system 100 to user 4, and user 4 replies, confirming registration.

Referring again to FIG. 5, once a user has become authenticated, there are several activities that can be undertaken. A first activity that can be undertaken is to manage the user's account. The Manage Account Activity is handled by the system access subsystem. The system access subsystem, as described above, is software that resides in user interface module according to a preferred embodiment of the present invention. According to other exemplary embodiment of the present invention, the system access subsystem software can reside in another or several other modules as shown in FIG. 1.

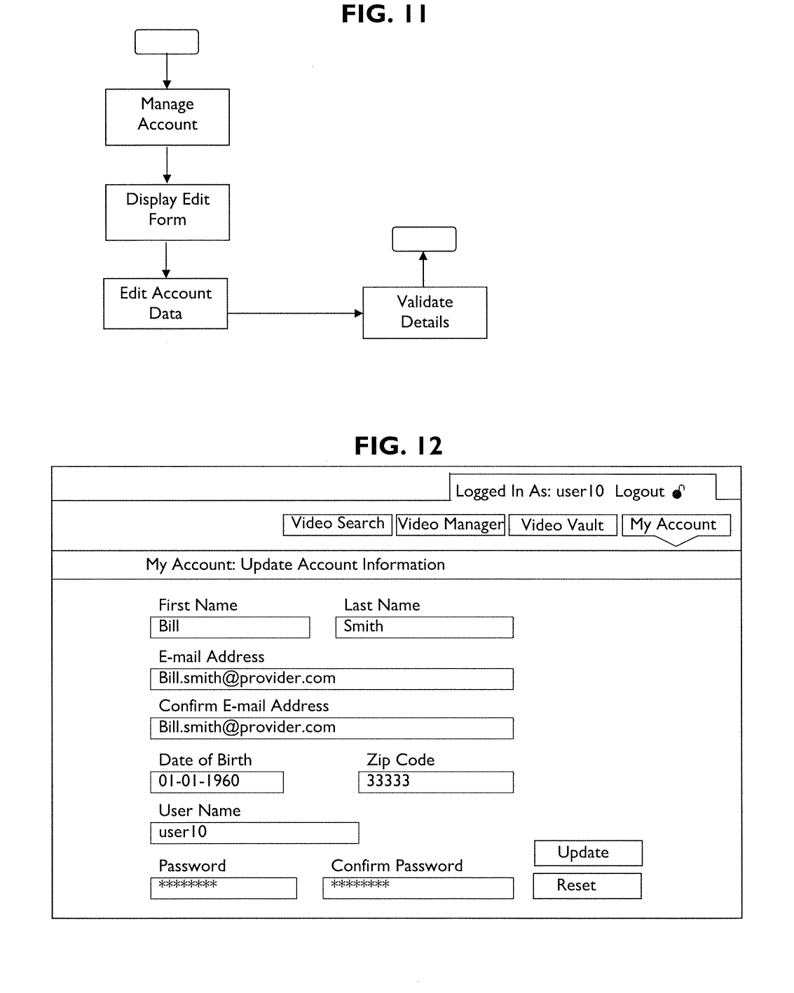

The manage account activity diagram is shown in FIG. 11. FIG. 11 illustrates an activity diagram for managing an account for use with the system and method according to an embodiment of the present invention. FIG. 12 illustrates a screen shot of a manage account page of a website used by the system and method for distributing multimedia information according to an embodiment of the present invention. FIG. 12 illustrates a screen shot of a “My Account” window that opens when user 4 selects the “My Account” button, located on the top right hand portion of the screen shot shown in FIG. 12. The first activity user 4 undertakes is to select the my account screen; system 100 then displays the screen shot of FIG. 12, and user 4 follows by editing his or her account data. As shown in FIG. 12, user 4 can change their name, email address, password, date of birth, zip code, username and/or password. One or more of the data fields can be altered. Once the new data has been entered, user 4 selects the “update” button, and system 100 validates the new data (as shown in the Manage Account Activity Diagram shown in FIG. 11), and user 4's account information is updated.

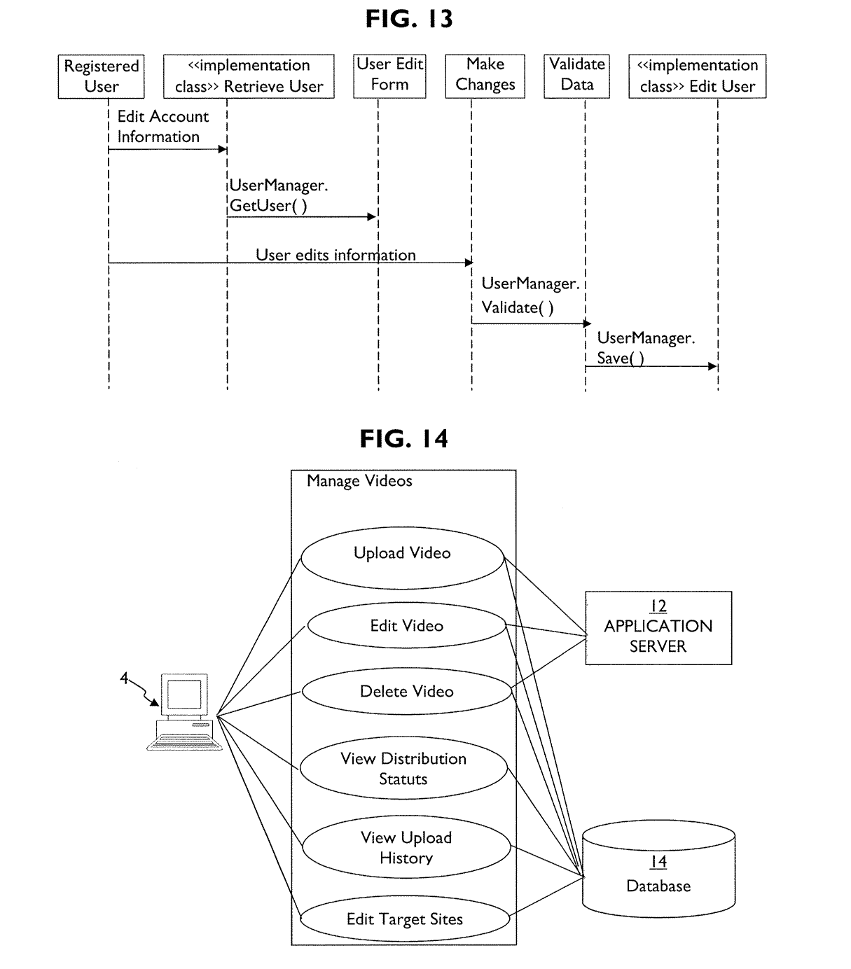

FIG. 13 illustrates a sequence diagram representing several activities of system 100 and authenticated users 4 when managing their account according to an embodiment of the present invention. As shown in FIG. 13, the registered or authenticated user 4 selects the manage account activity, and system 100 retrieves the appropriate form (the screen shot shown in FIG. 12). User 4 then edits account information, as discussed above, and system 100, through user interface module 110, validates the changes to the user's account information. The new data is then implemented, and the user's account is thus updated.

### B. Multimedia Information Distribution Module 125

### 1. Description

The system 100 further includes a multimedia information distribution module 125 in communication with the user interface module 110. The multimedia information distribution module 125 is configured to distribute the multimedia information 115 to the one or more remote sites 120 in accordance with the multimedia information distribution indications. For example, if the user specifies one or more network addresses (e.g., URLs or IP addresses) for the multimedia information distribution indications, the multimedia information distribution module 125 can distribute or otherwise communicate the multimedia information 115 to those network addresses using conventional network communication techniques and mechanisms.

Accordingly, the multimedia information distribution module 125 is configured to interface to and communicate with the one or more remote sites 120. For example, to facilitate such communication, the multimedia information distribution module 125 can include a communication module 130. The communication module 130 is capable of communicating appropriate information to and from the system 100 via, for example, any suitable type of network 135, such as, for example, an intranet, an internet (e.g., the Internet or World Wide Web) or the like. For example, the communication module 130 can be used to communicate information to and from the users or other systems (e.g., remote databases, information systems or the like for obtaining information for use by or supplying information generated from the system 100).

According to an exemplary embodiment, the user can manipulate the multimedia information 115 either before or after such information is distributed. For example, the multimedia information distribution module 125 can be configured to edit the multimedia information 115 in accordance with commands received from the user via the user interface module 110. Additionally or alternatively, the multimedia information distribution module 125 can be configured to edit multimedia characteristic information (e.g., metadata or the like) in accordance with commands received from the user via the user interface module 110. Furthermore, the multimedia information distribution module 125 can be configured to delete multimedia information 115 from one or more of the remote sites 120 in accordance with instructions received from the user via the user interface module 110.

### 2. Use Cases

a. Upload Videos. Referring back to FIGS. 5 and 14, a next activity that a user can perform is the upload videos activity. The upload video activity that is accessible through the login page occurs using a manage videos subsystem, which, according to an exemplary embodiment of the present invention, can be software that manages video data. The manage videos subsystem resides primarily within multimedia information distribution module 125 according to a preferred embodiment of the present invention, though, as one of ordinary skill in the art of the present invention can appreciate, the manage video subsystem software can reside in another, or more than one modules, as described herein.

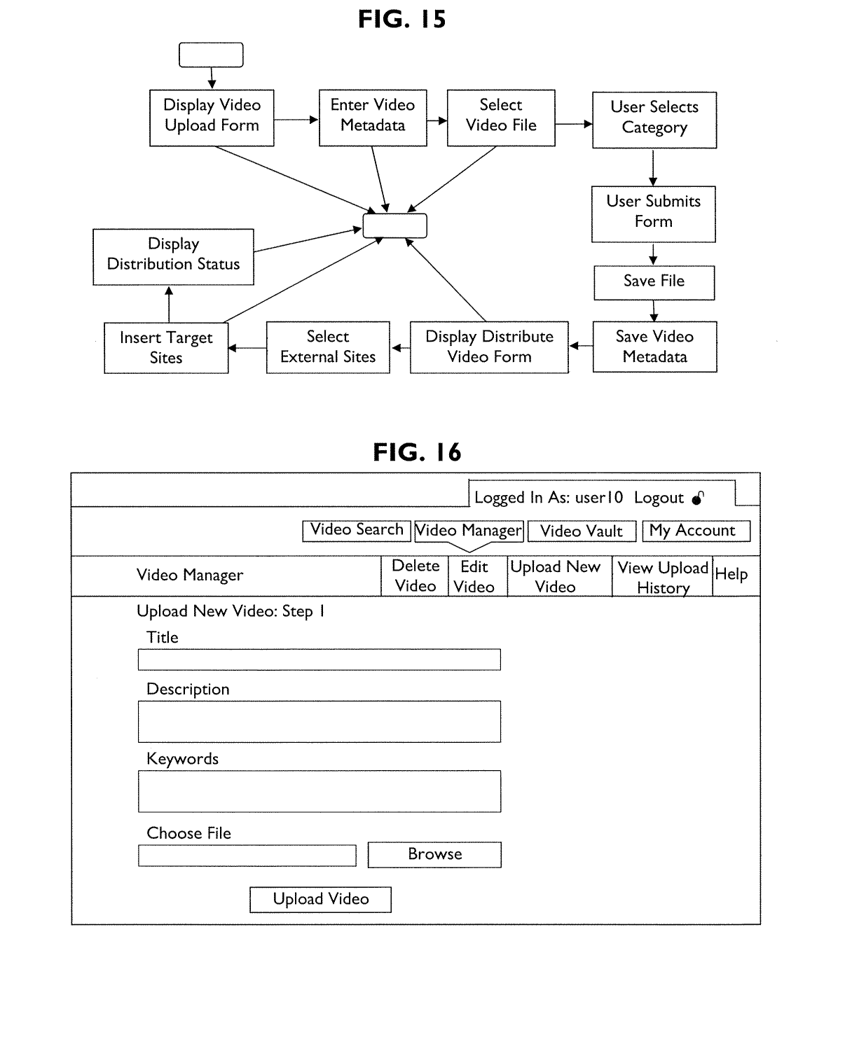

FIG. 14 is a block diagram illustrating several functional actions that a manage video subsystem program can perform by users when accessing a system according to an embodiment of the present invention. The actions that users can perform in regard to videos includes uploading videos, editing videos, deleting videos, viewing distribution status of videos, view upload history of one or more videos, and editing target sites where the videos have been uploaded to. Each action shall be discussed in turn. FIG. 15 is an activity diagram that illustrates the steps that system 100 and user 4 perform when uploading videos to system 100 according to an embodiment of the present invention, and FIG. 16 is a screen shot of the home page after user 4 has selected the Video Manager button, located along an upper tool bar on the graphically displayed window.

Referring to FIG. 15, user 4 selects video to upload from his or her computer's hard drive, external storage device, external digital video camera, or any other type of storage medium accessible through the user's 4 computer. System 100 then displays an Upload Video Form (the screen shot shown in FIG. 16). User 4 enters the required metadata into the form fields. Examples of metadata (“data about data”) can include the title of the video, a description, one or more keywords, the file type of the digital video data. According to additional embodiments of the present invention, other types of metadata can be added (length, characters, plot information, location of shooting of video, among other types), or the fields presently shown in FIG. 16 can be left blank at the user's 4 discretion. User 4 then selects the file to upload by selecting the browse button as shown in FIG. 16. Although not shown in FIG. 16, user 4 can also select a video category, and then presses the upload video button to submit the form and the metadata and video file.

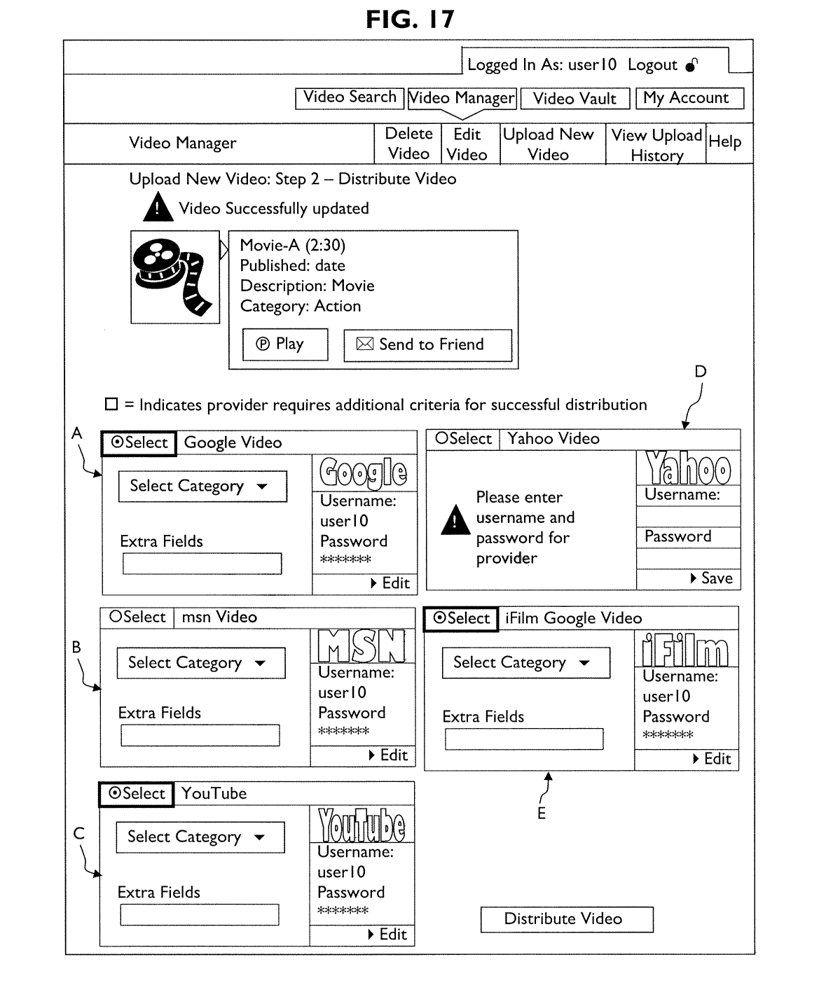

System 100 then stores the video file (including the video data and video metadata) in database 14 (the file is stored in the file storage system (database 14), encoded to flash, and stored in the streaming system), as well as the file location and metadata. System 100 then displays the Distribute Video screen shot shown in FIG. 17. FIG. 17 illustrates a screen shot of an distribute video page of a website used by the system and method for distributing multimedia information according to an embodiment of the present invention. Windows A-E represents video upload sites that user 4 can select to distribute videos. The necessary log-in information is saved for each provider to which user has previously distributed videos. When the log-in information is not saved, the user can enter the necessary log-in information prior to distributing the video. According to a preferred embodiment of the present invention, user 4 only has to click on the select button, and the user's video will be uploaded to that site. The simple act of selected a video upload site by merely clicking on a single button for each video upload site saves user 4 large amounts of time, and substantially eliminates or reduces the possibility of errors when registering at individual sites. User 4 then clicks on the Re-distribute video button, and system 100 processes the form shown in FIG. 17 as a screen shot, and distributes the video. System 100 can then display an upload status, indicating when upload was successfully implemented.

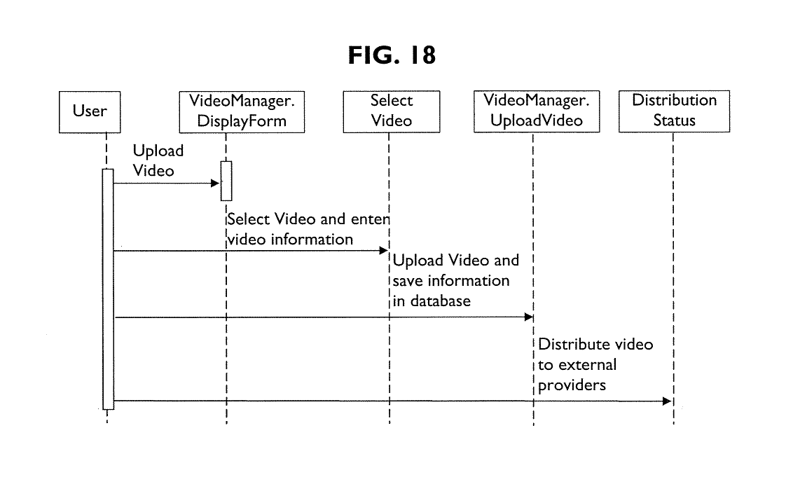

FIG. 18 illustrates a sequence diagram representing several activities of system 100 and authenticated users 4 when uploading video to one or more external sites according to an embodiment of the present invention. As shown in FIG. 18, the registered or authenticated user 4 selects the upload video activity, and the video manager/display form (screen shot shown in FIG. 16) is then displayed. A video is then selected by the user 4, and pertinent video information is entered (“Select Video”). A video manager/upload video sequence occurs, wherein the selected video is uplifted and then transferred and stored on the database. Finally, a distribution status sequence occurs, which distributes the video to all of the external providers selected by the user.

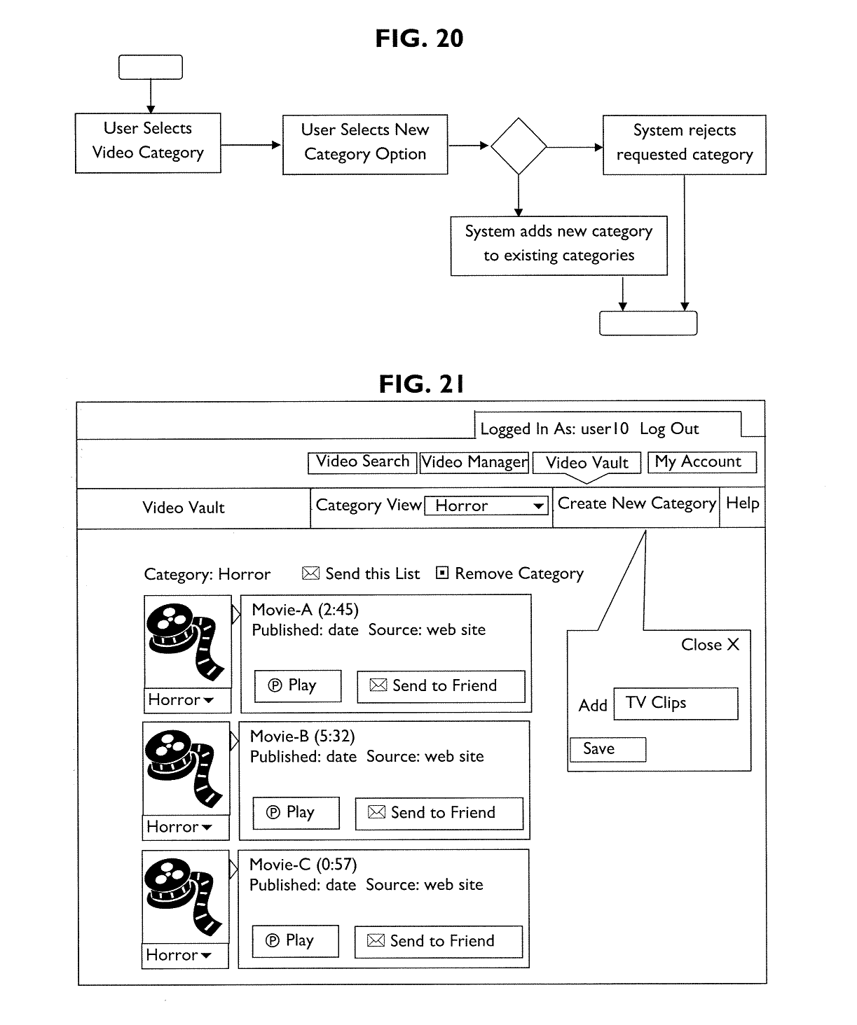

Another activity that can occur in regard to uploading video according to an embodiment of the present invention is creation of a new category of video. It is possible that a user can upload their own video that defies all then existing video categories, In that case, user 4 can create a new category of video to upload to the system of the present invention. Alternatively, even though existing categories can more or less adequately describe the genre of the video, user 4 may determine that it would be preferable to personalize the category of the soon-to-be-uploaded video in order for it to reach wider audiences. Thus, according to an alternate embodiment of the present invention, user 4 can create a new category of video. FIG. 20 illustrates an activity diagram for creation of a new video category using the system and method according to an embodiment of the present invention. The activity in FIG. 20 begins with user 4 selecting a new video category form. System 100 presents a new video category form to user 4, and user 4 enters the new category. If the new category is recognized as already being present in system 100, then system 100 will reject the new category. Otherwise, system 100 then accepts the new category, and adds it to the video category list. FIG. 21 illustrates a screen shot of an create video category page used by system 100 and method 200 for creating a new video category according to an embodiment of the present invention. According to an exemplary embodiment of the present invention, system 100 has added “TV Clips” as a new video category for user 4. FIG. 21 represents a graphical user interface after the new video category has been successfully added.

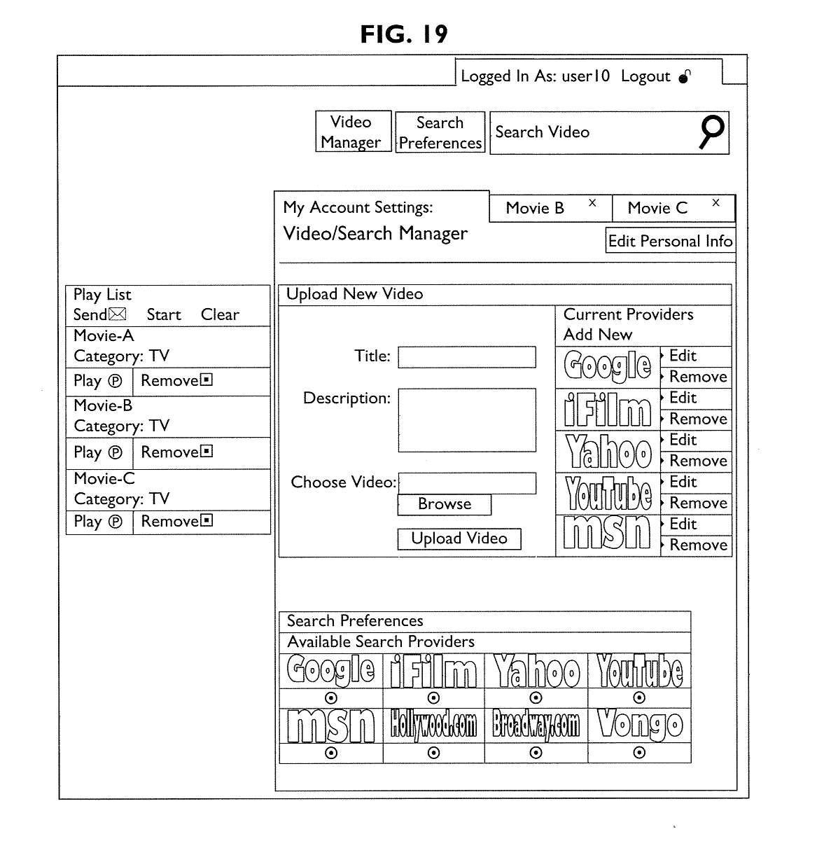

FIG. 19 illustrates a screen shot of an upload new video page used by the system and method for distributing multimedia information according to an embodiment of the present invention. FIG. 19 illustrates what occurs when user 4 selects upload video, and, from the screen shot shown in FIG. 17, clicks the “Select Category” field in, for example, any of windows A-E. User 4 can then enter a title, description, and other multimedia information. User 4 can also choose the site to upload the chosen video; in the sub window of current providers, video search providers are listed for users 4 to select. Each video provider can be edited or removed as a video upload destination. Finally, user 4 clicks on “Upload Video” to complete the upload process.

b. Edit Videos. Referring back to FIGS. 5 and 14, a next activity that a user can perform is the edit videos activity. The edit video activity that is accessible through the login page occurs using a manage videos subsystem, which, according to an exemplary embodiment of the present invention, can be software that manages video data. As discussed supra, the manage videos subsystem resides primarily within multimedia information distribution module 125 according to a preferred embodiment of the present invention, though, as one of ordinary skill in the art of the present invention can appreciate, the manage video subsystem software can reside in another, or more than one modules, as described herein. FIG. 14 is a block diagram illustrating several functional actions that a manage video subsystem program can perform by users when accessing a system according to an embodiment of the present invention. A next action that user 4 can perform in regard to videos is, for example, editing videos.

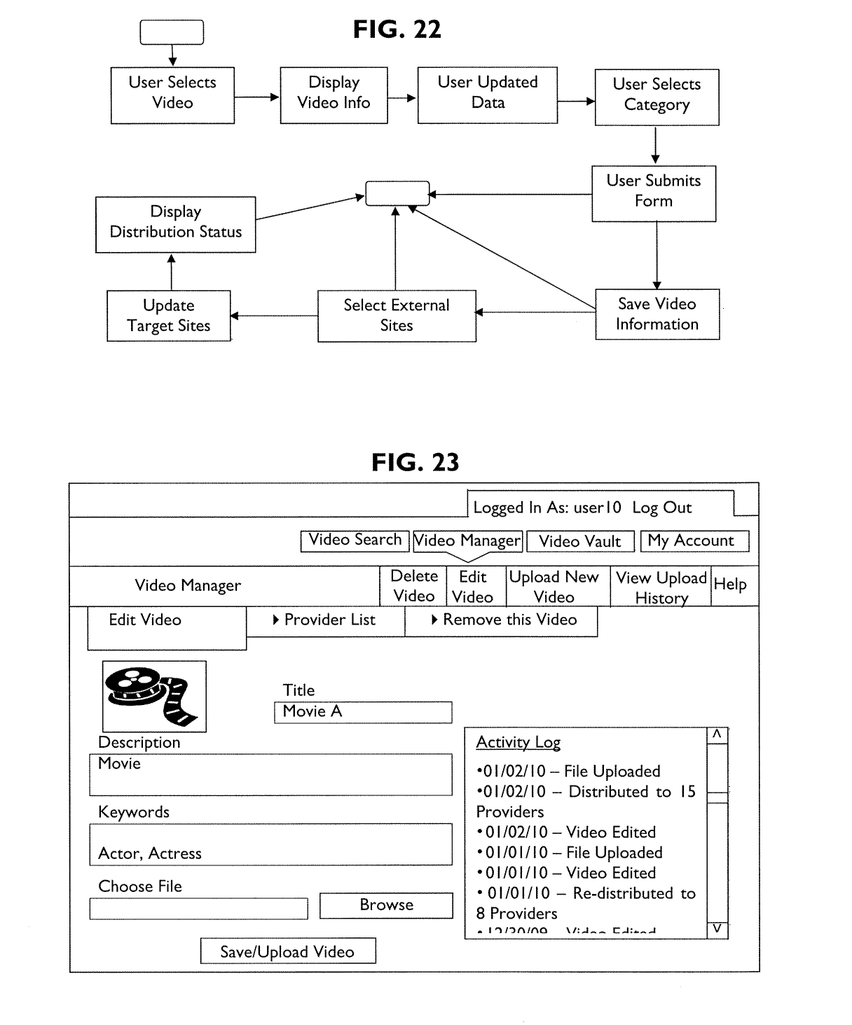

FIG. 22 is an activity diagram that illustrates the steps that system 100 and user 4 perform when editing videos stored within system 100 according to an embodiment of the present invention. As those of ordinary skill in the art of the present invention can appreciate, the steps described below regarding implementation of an edit video activity represents only one exemplary embodiment of performing such activity, and as such, the embodiments of the present invention are not limited to the particular method shown and discussed. The edit video activity begins when user 4 selects the video manager button shown in the FIG. 9 screen shot. The video manager screen shot, FIG. 17, is then displayed and then user 4 selects the edit video button shown in FIG. 16 to display the screen shown in FIG. 23. User 4 can browse to select a video, and then system 100 displays video information for the selected video as shown in the windows in FIG. 23. According to an exemplary embodiment of the present invention, user 4 can choose none, or one or more of the title, description, and keywords to provide updated information. Following input of new/updated information, user 4 selects a video category, and clicks on the save/upload button, thus submitting the appended form.

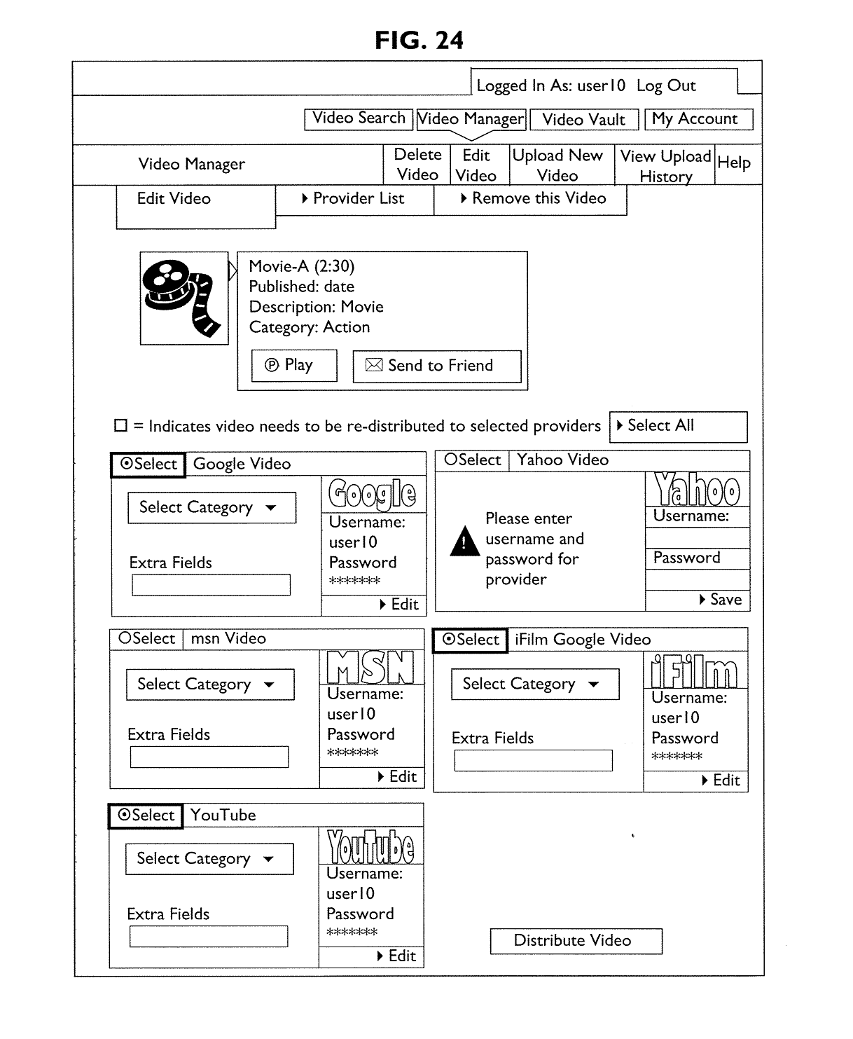

System 100 stores the data in database 14, and displays a list of external sites where the video is distributed, as shown in FIG. 24. According to a preferred embodiment of the present invention, user 4 can then select different external sites to redistribute the updated data. As those of ordinary skill in the art can appreciate, user 4 can select to have all the external sites receive the same updated information. Accordingly, system 100 then re-distributes the data after the “re-distribute” button is selected by user 4.

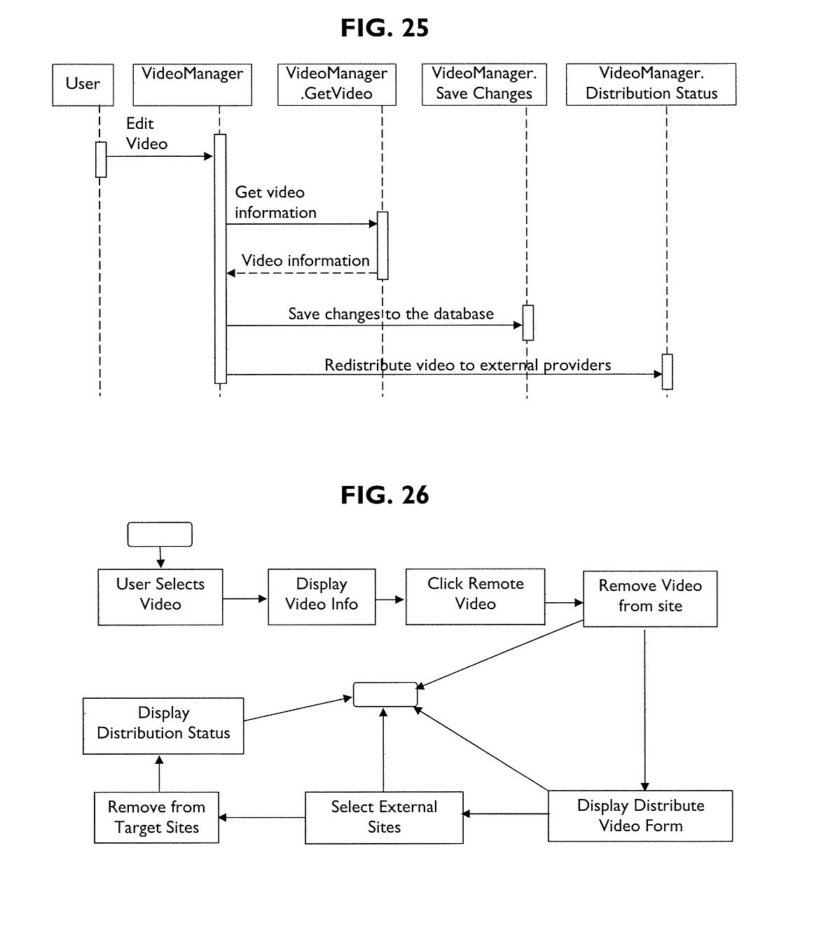

FIG. 25 illustrates a sequence diagram representing several activities by the system and method for distributing multimedia information and authenticated users when uploading updated multimedia information to one or more external sites according to an embodiment of the present invention. User 4 selects the edit video function, and an edit video request is forwarded to the video manager subsystem. The video manager subsystem requests and receives the old video information from video manager/get video sub-subsystem. Once the new video information is entered, it becomes stored when a save video data request is made, which is received by the video manager/save changes sub-subsystem. Finally, the video is redistributed, along with the updated video data to one or more external sites through use of the video manager/distribution status sub-subsystem. Accordingly, user 4's updated video data has been redistributed according to his or her instructions.

c. Delete Videos. FIG. 26 is an activity diagram that illustrates the steps that the system and method for distributing multimedia information perform when deleting videos stored within system 100 according to an embodiment of the present invention. As those of ordinary skill in the art of the present invention can appreciate, user 4 may delete certain videos that have been uploaded to system 100. Referring back to FIGS. 5 and 14, a next activity that a user can perform is the delete videos activity. The delete video activity that is accessible through the login page occurs using the manage videos subsystem, which, according to an exemplary embodiment of the present invention, can be software that manages video data. As discussed supra, the manage videos subsystem resides primarily within multimedia information distribution module 125 according to a preferred embodiment of the present invention, though, as one of ordinary skill in the art of the present invention can appreciate, the manage video subsystem software can reside in another, or more than one modules, as described herein. As discussed above, FIG. 14 is a block diagram illustrating several functional actions that a manage video subsystem program can perform by users when accessing a system according to an embodiment of the present invention. A next action that user 4 can perform in regard to videos is, for example, deleting videos.

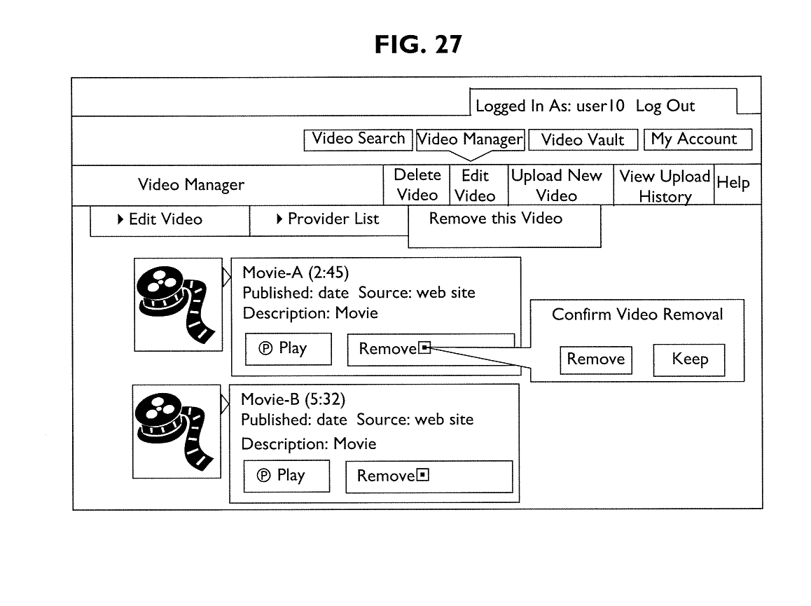

Referring to FIGS. 16 and 25, the function of deleting a video begins with user 4 selecting the edit video button to display the screen shown in FIG. 27. In FIG. 27 user 4 browses and selects videos to delete that are associated with user's 4 account. System 100 then displays video information pertaining to the selected videos, and user 4 clicks on the remove video link to instruct system 100 to delete the selected video(s) from user's 4 account. The screen shown in FIG. 27 is then altered by system 100 to show a distribute video form; the distribute video form shows where the selected video currently has been distributed to, in accordance with the upload video activity previously performed by user 4 and system 100 according to embodiments of the present invention.

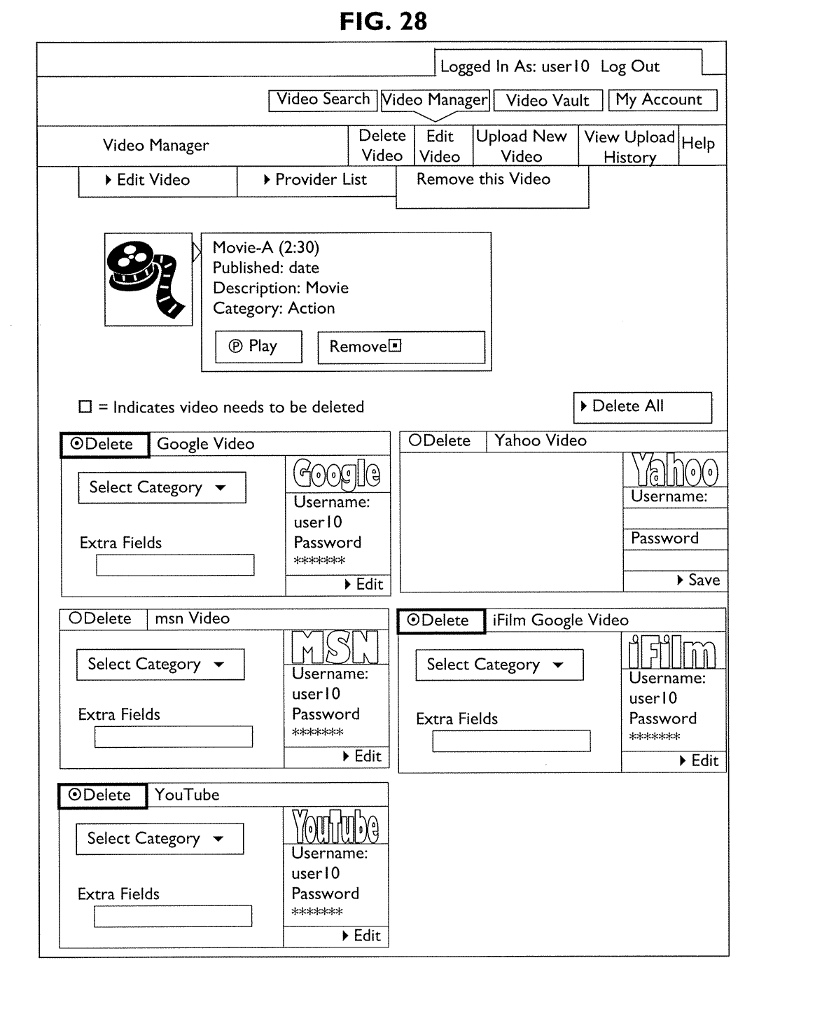

User 4 then selects the different external site(s) from which the video should be deleted, and clicks on the “delete video” button. System 100 then issues instructions to the selected external sites to delete the one or more videos selected for deletion, and updates the distribution status within system 100. An updated distribution status display is created and displayed, as shown in FIG. 28.

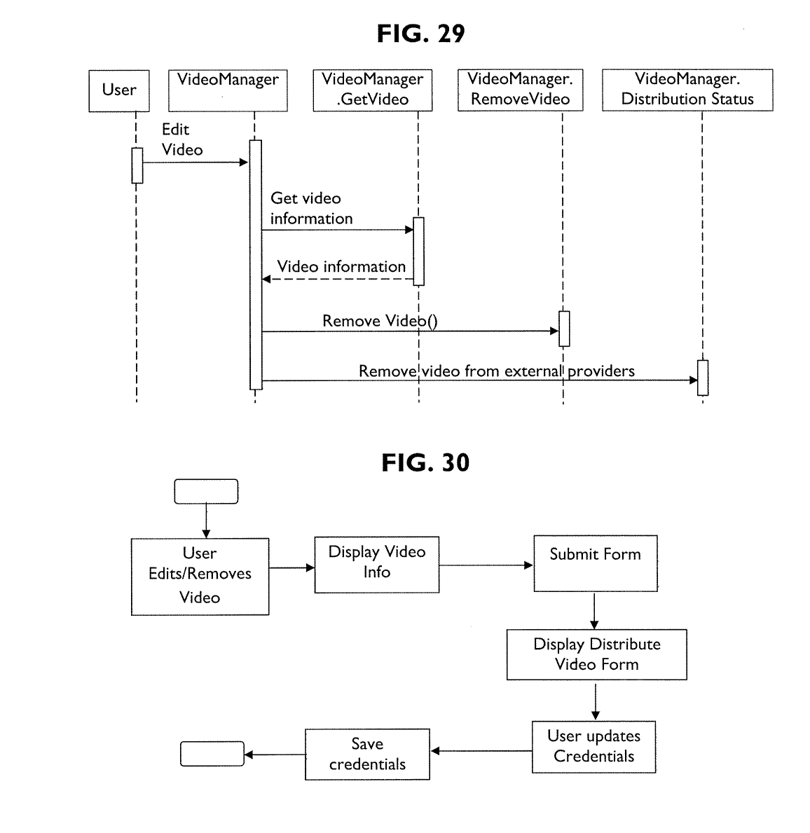

FIG. 29 illustrates a sequence diagram representing several activities by the system and method for distributing multimedia information and authenticated users when deleting multimedia information from one or more external sites according to an embodiment of the present invention. The sequence diagram shown in FIG. 29 illustrates the flow of information between and among different entities of system 100 according to an embodiment of the present invention for deleting one or more videos from one or more external sites. The sequence for deleting one or more videos begins with user 4 selecting the edit video function via the edit video button to display the screen shown in FIG. 23. The video manager subsystem acquires the selected videos from the video manager/get video sub-subsystem, and displays the selected video information. User 4, through the video manager subsystem, then deletes the videos by clicking on the aforementioned “delete video” button, and the video manager remove video subsystem is updated with that information by the video manager subsystem. The video manager subsystem then issues commands to the video manager distribution sub-subsystem, which provides instructions to the external sites to delete the videos.

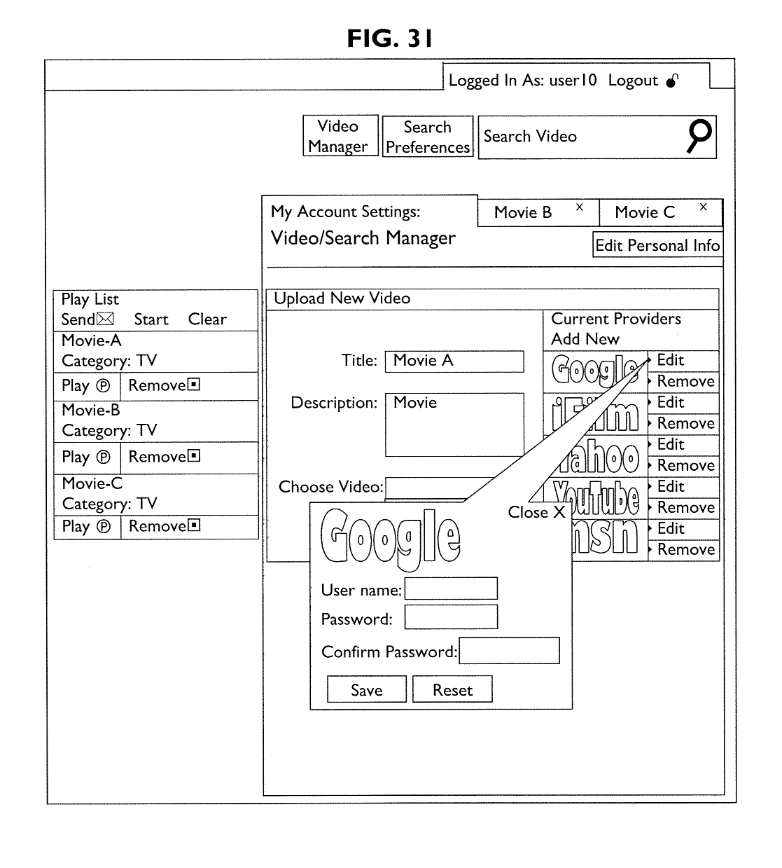

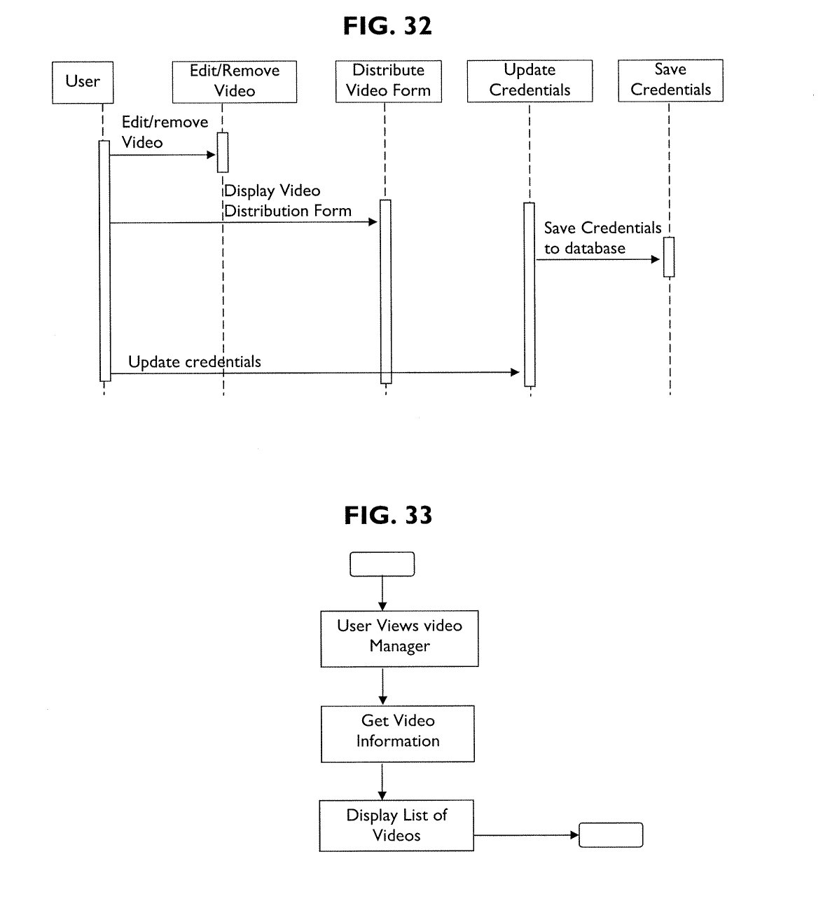

d. Edit Target Sites. FIG. 30 is an activity diagram that illustrates the steps that the system and method for distributing multimedia information perform when editing target sites accessed by system 100 according to an embodiment of the present invention. Referring to FIG. 30, target sites are edited when user 4 uploads new video, edits video, or removes video, as discussed supra. Following the uploading of a new video, or editing of video information, or deleting one or more videos from one or more external video sites, system 100 also causes links to the one or more various external sites to be displayed. User 4 can then edit or insert credentials on the one or more external sites. System 100 then stores user 4 credentials of external sites in the database 14. FIG. 31 illustrates a screen shot of an edit target site page used by system 100 and method 200 for distributing multimedia information according to an embodiment of the present invention, and FIG. 32 illustrates a sequence diagram representing several activities by system 100 and method 200 for distributing multimedia information and authenticated users when editing target sites according to an embodiment of the present invention. Referring now to FIG. 32, the sequence for editing target sites begins when user 4 edits, removes, or uploads video data (the “edit information”). The edit information is transferred to an edit/remove video subsystem, which then causes the distribution video form to be displayed. The distribution video form indicates that user 4 should provide and/or update user 4 credentials to the one or more external sites. User 4 provides the new or changed credentials and an update credential sub-subsystem accepts them and then forwards them to the various external sites, as well as to a system 100 database via save credentials sub-subsystem.

e. View Upload History. FIG. 33 is an activity diagram that illustrates the steps that system 100 and method 200 for distributing multimedia information performs when viewing an upload history of videos stored within system 100 according to an embodiment of the present invention. Referring back to FIGS. 5 and 14, a next activity that a user can perform is the view upload video history. The view upload video history activity that is accessible through the login page occurs using the manage videos subsystem, which, according to an exemplary embodiment of the present invention, can be software that manages video data. As discussed supra, the manage videos subsystem resides primarily within multimedia information distribution module 125 according to a preferred embodiment of the present invention, though, as one of ordinary skill in the art of the present invention can appreciate, the manage video subsystem software can reside in another, or more than one modules, as described herein. As discussed above, FIG. 14 is a block diagram illustrating several functional actions that a manage video subsystem program can perform by users when accessing a system according to an embodiment of the present invention. A next action that user 4 can perform in regard to videos is, for example, viewing upload history of one or more videos at one or more external sites.

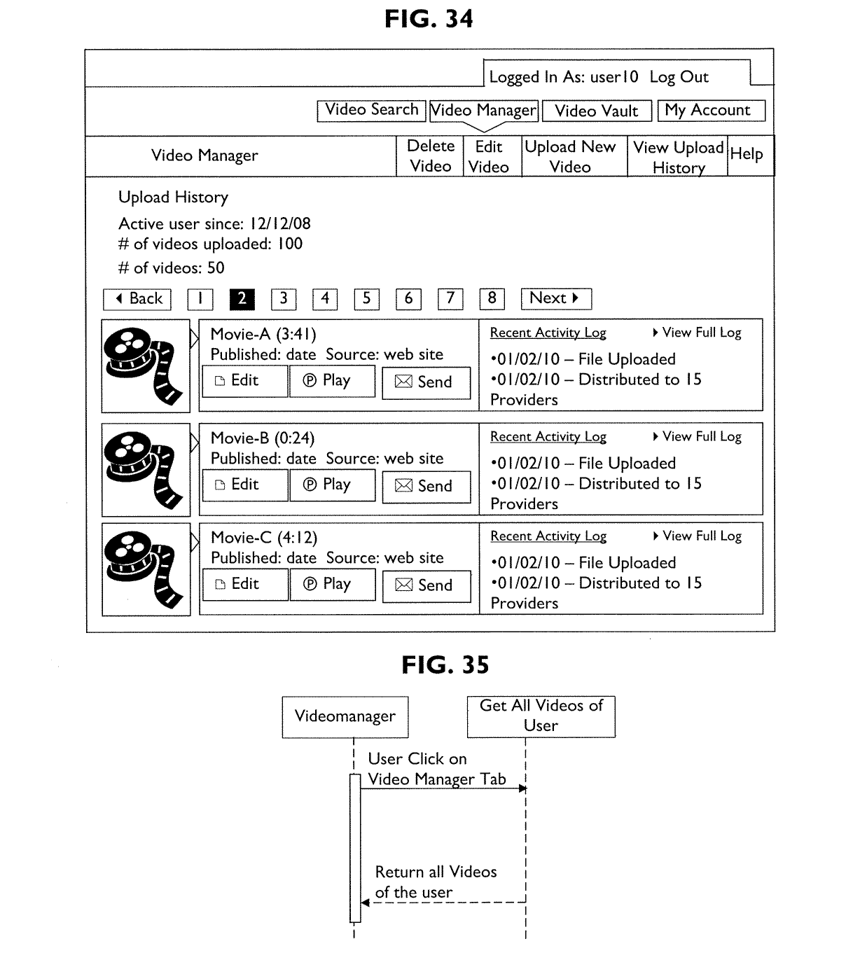

Referring to FIGS. 16 and 34, the function of viewing video upload history begins with user 4 selecting the view upload history button as shown in FIG. 16; then, FIG. 34 appears. In FIG. 34, all of user's 4 uploaded videos appears, along with an condensed activity log. If desired, User 4 can then select to view the full log, and a more detailed activity log appears. In the full and condensed activity log, each upload activity is shown, along with the date of the uploading, and any other activity that occurred in regard to that particular video (editing information, editing external site, uploading new or edited credentials, for example). Use of the video uploaded history provides user 4 with detailed information about the upload status of the videos placed on the various external sites.

FIG. 35 illustrates a sequence diagram representing several activities by system 100 and method 200 for distributing multimedia information and authenticated users when viewing an upload history according to an embodiment of the present invention. As shown in FIG. 35, when user 4 clicks on the video manager tab, the video manager subsystem returns the screen shown in FIG. 16. User 4 then selects the view upload history button, and the get all videos of user sub-subsystem returns, for example, the screen shown in FIG. 34, which displays the activity log for all of user's 4 videos.

f. View Distribution Status. FIG. 36 is an activity diagram that illustrates the steps that system 100 and method 200 for distributing multimedia information performs when viewing a distribution status of videos stored within system 100 according to an embodiment of the present invention. Referring back to FIGS. 5 and 14, a next activity that a user can perform is the view distribution status. The view distribution status activity that is accessible through the login page occurs using the manage videos subsystem, which, according to an exemplary embodiment of the present invention, can be software that manages video data. As discussed supra, the manage videos subsystem resides primarily within multimedia information distribution module 125 according to a preferred embodiment of the present invention, though, as one of ordinary skill in the art of the present invention can appreciate, the manage video subsystem software can reside in another, or more than one modules, as described herein. As discussed above, FIG. 14 is a block diagram illustrating several functional actions that a manage video subsystem program can perform by users when accessing a system according to an embodiment of the present invention. A next action that user 4 can perform in regard to videos is, for example, viewing view distribution status of one or more videos from one or more external sites to one or more other users of the external sites.

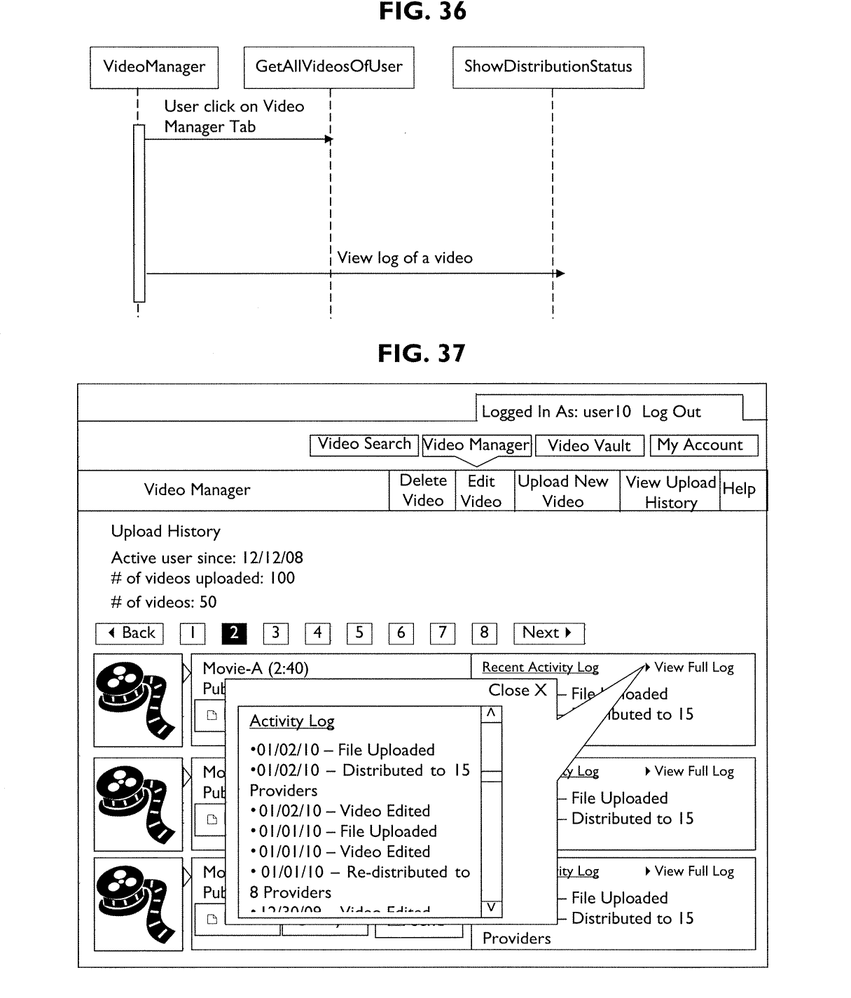

Referring to FIGS. 16 and 36, the function of viewing distribution status of user's 4 videos begins with user 4 selecting the video manager tab to display the screen in FIG. 16. System 100 then retrieves all the videos uploaded by user 4. As shown in FIG. 16, all of user's 4 uploaded videos appears, along with a view log button. User 4 then clicks on the view log of any video, and system 100 retrieves the sequence of the events for that video and displays them on as shown in FIG. 37. According to an exemplary embodiment of the present invention, the following non-limiting list of events for the video will be logged by system 100: uploading video on site; distribution of video to external providers; editing of the video; editing the video on external providers' site(s); deleting the video from the site; deleting the video from external sites; and sending the video to a friend.

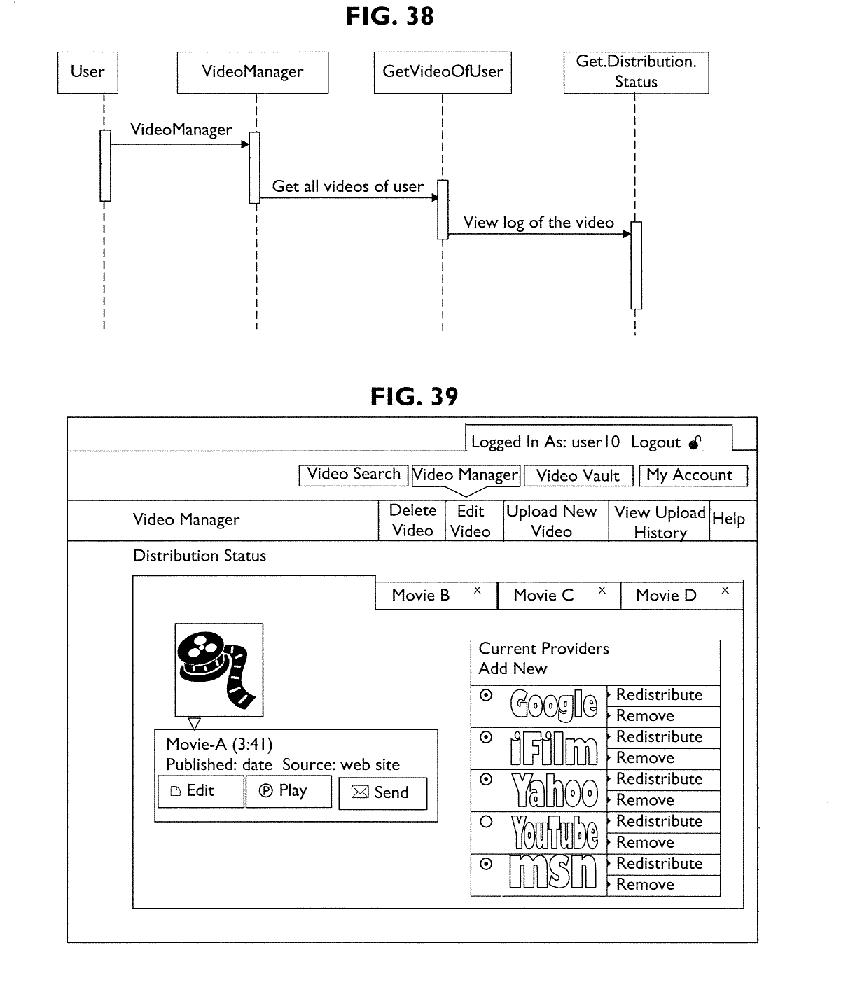

FIG. 38 illustrates a sequence diagram representing several activities by system 100 and method 200 for distributing multimedia information and authenticated users when viewing a distribution status according to an embodiment of the present invention. As shown in FIG. 38, when user 4 clicks on the video manager tab, the video manager subsystem returns the screen shown in FIG. 16, and forwards a “get all videos of user” command to get video of user sub-subsystem. System 100 lists all the uploaded videos for user 4, and user 4 then selects the view distribution status button for the desired video, and the get video of user sub-subsystem forwards a command to the get distribution status sub-subsystem, which lists the distribution status for the selected video. An example of the distribution status for a particular video is shown in FIG. 39.

### C. Multimedia Information Search Module 140

The system 100 can further include a multimedia information search module 140 in communication with the multimedia information distribution module 125. As discussed briefly above, the multimedia information search module 140 can be configured to search for multimedia information 115 uploaded by the user. Additionally or alternatively, the multimedia information search module 140 can be configured to search for multimedia information located on the one or more remote sites 120. For example, any multimedia information that has been located by the multimedia information search module 140 can then be downloaded to the user.

### D. Multimedia Information Management Module 145

The system 100 can include a multimedia information management module 145 in communication with the multimedia information distribution module 125. The multimedia information management module 145 can be configured to manage the multimedia information 115 and multimedia characteristic information (e.g., metadata or the like) associated with the multimedia information 115. Thus, in some embodiments, the multimedia information management module is configured to manage the multimedia information such that it displays, for example, the one or more remote sites 120 to which the multimedia information has been distributed; when the multimedia information was distributed to the one or more remote sites; how many users have viewed the distributed multimedia information and at what one or more remote sites the distributed multimedia information has been viewed; comments, if any, that other users may have posted regarding the multimedia information; revenue, if any, that has been generated from the distribution of the multimedia information to the one or more remote sites; when the multimedia information was edited, if applicable; and if and when the multimedia information was re-distributed to the one or more remote sites after it was edited.

### E. Database Module 150

### 1. Description

The system 100 can include a storage or database module 150 in communication with the multimedia information distribution module 125. The database module 150 can be configured to store the multimedia information 115 or any other appropriate information generated or used by the system 100, including, but not limited to user characteristic information, multimedia characteristic information, and metadata. The database module 150 can be comprised of any suitable type of computer-readable or other computer storage medium capable of storing information in electrical or electronic form.

According to exemplary embodiment, the multimedia information 115 can comprise any suitable type of electrical or electronic media file that is capable of being distributed over the network 135 to one or more remote sites 120. For example, the multimedia information 115 can comprise video multimedia information files, audio multimedia information files, photographic multimedia information files, or the like.

Those of ordinary skill in the art will recognize that each of the modules of the system 100 can be located locally to or remotely from each other, while use of the system 100 as a whole still occurs within a given country, such as the United States. For example, merely for purposes of illustration and not limitation, the multimedia information distribution module 125 (including the communication module 130), the multimedia information search module 140, the multimedia information management module 145, and the database module 150 (or any combination of such modules) can be located extraterritorially to the United States (e.g., in Canada and/or in one or more other foreign countries). However, the user interface module 110 can be located within the United States, such that the control of the system 100 as a whole is exercised and beneficial use of the system 100 is obtained by the user within the United States.

Each of modules of the system 100, including the user interface module 110, multimedia information distribution module 125 (including the communication module 130), the multimedia information search module 140, the multimedia information management module 145, the database module 150, or any combination thereof, can be comprised of any suitable type of electrical or electronic component or device that is capable of performing the functions associated with the respective element. According to such an exemplary embodiment, each component or device can be in communication with another component or device using any appropriate type of electrical or optical connection that is capable of carrying (e.g., electrical, optical, infrared) information. Alternatively, each of the modules of the system 100 can be comprised of any combination of hardware, firmware and software that is capable of performing the functions associated with the respective module.

Alternatively, the system 100 can be comprised of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

### 2. Uses Cases

Alternative architectures or structures can be used to implement the various functions of the system 100 as described herein. For example, functions from two or more modules can be implemented in a single module, or functions from one module can be distributed among several different modules.

### III. Method for Uploading and Distributing Multimedia Information

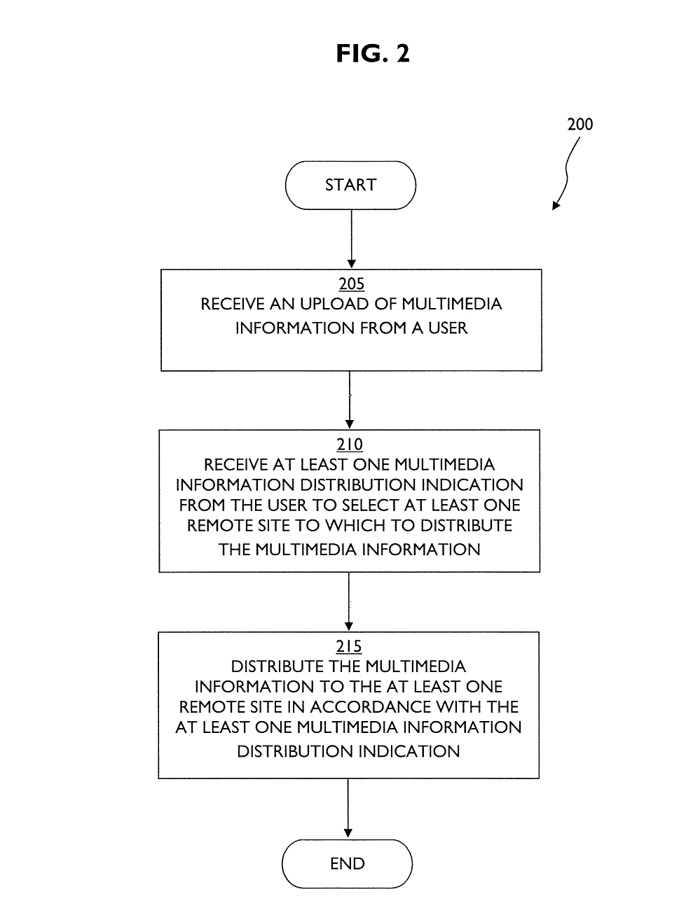

FIG. 2 is a flowchart illustrating steps for distributing multimedia information, in accordance with an exemplary embodiment of the present invention. In step 205, an upload of multimedia information is received from a user. In step 210, one or more multimedia information distribution indications are received from the user to select one or more remote sites to which to distribute the multimedia information. In step 215, the multimedia information is distributed to the one or more remote sites in accordance with the multimedia information distribution indications.

Each, all or any combination of the steps of a computer program as illustrated in FIG. 2 for distributing multimedia information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system or process for distributing multimedia information to one or more remote sites, e.g., over a network. For example, exemplary embodiments of the present invention can be used to upload a video file from the user to the system, and the system can then distribute the video to a plurality of websites on behalf of the user. In such a manner, the user is not required to manually upload the video file to each desired site, thereby providing a savings in time and expense to the user.

### IV. Additional Subsystems for Use by the System and Method for Distributing Multimedia Information

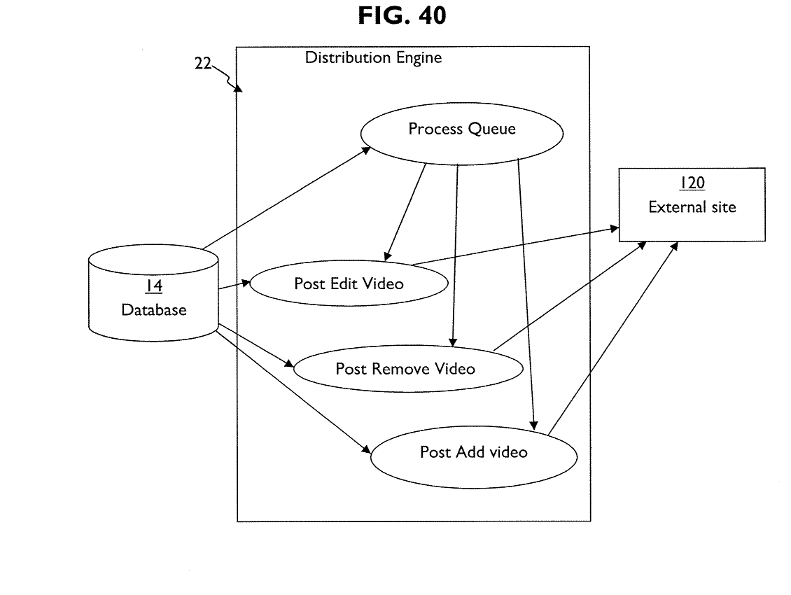

A. Distribution Engine Subsystem 22. FIG. 40 illustrates a top-level representation of a distribution engine subsystem 22 that enables database 14 of system 100 and external sites 120 used by system 100 to interface with each other according to an embodiment of the present invention. FIG. 4 illustrates a top level diagram of a software module (distribution engine subsystem 22) used by system 100 and method 200 to enable database 14 and external sites 120 to communicate with each other, and effect certain actions, as described herein. According to a preferred embodiment of the present invention, distribution engine subsystem 18 is software that interfaces with external sites 18 to upload, edit and remove videos on behalf of user 4. Distribution engine 22 is accessed by database 14 in response to certain other actions, as discussed throughout. The process queue controls the flow of certain operations within distribution engine 22. The certain operations can include post add video, post remove video, and post add video. Each shall be discussed in turn. Each of the operations has both a use case and a sequence diagram that further describes their operation according to an embodiment of the present invention.

### 1. Post Add Video.

Process queue sub-subsystem determines which of three processes, post add video, post remove video, and post edit video are called up when user 4 is performing an action in regard to videos stored within system 100. According to an exemplary embodiment of the present invention, process queue sub-subsystem calls up post add video if user 4 decides to upload video to system 100; process queue sub-subsystem calls up post edit video if user decides to edit video within system 100; and process queue sub-subsystem calls up post remove video if user 4 decides to remove or delete videos from system 100.

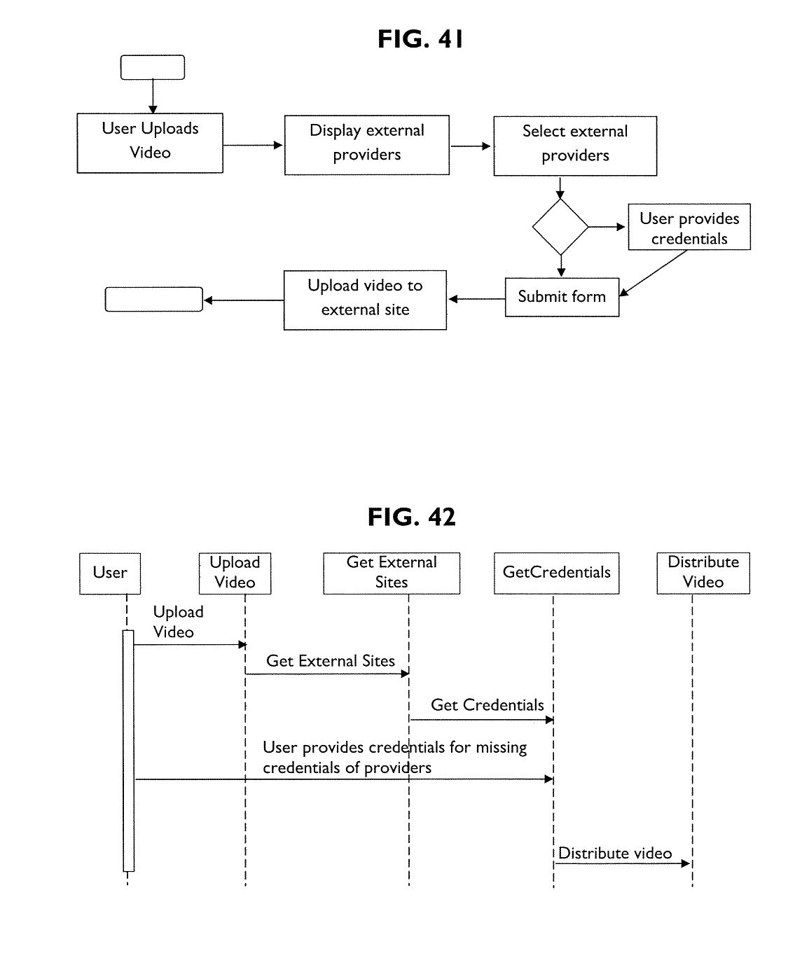

a. Activity Diagram. Referring now to FIG. 41, an activity diagram for the post add video process is shown in accordance with an exemplary embodiment of the present invention. The post add video activity begins when user 4 uploads a video. A list of external providers 120 is displayed. User 4 then selects one or more external providers to which the video should be distributed. System 100 provides user's 4 credentials of each of those external providers, and user 4 clicks on the appropriate tab, and submits the video upload form. System 100 then uploads the video to each of the selected external providers. As those of ordinary skill in the art of the present invention can appreciate, the post add video process describes an operation similar to that of uploading videos described supra in regard to user 4 and manage videos subsystem 18.

b. Sequence Diagram. FIG. 42 illustrates a sequence diagram for the post add video process described in reference to FIG. 41. The sequence of operations for performing the post add video process according to an exemplary embodiment of the present invention begins with user 4 selecting the upload video tab. Then, the upload video sub-subsystem requests a list of external providers from the get external sites sub-subsystem. The get external sites sub-subsystem issues a request for credentials to the get credentials sub-subsystem. The get credentials sub-subsystem either provides previously stored credentials, or obtains them from user 4. The get credentials sub-subsystem then issues a distribute videos command to the distribute video sub-subsystem, which then distributes the videos.

### 2. Post Remove Video.

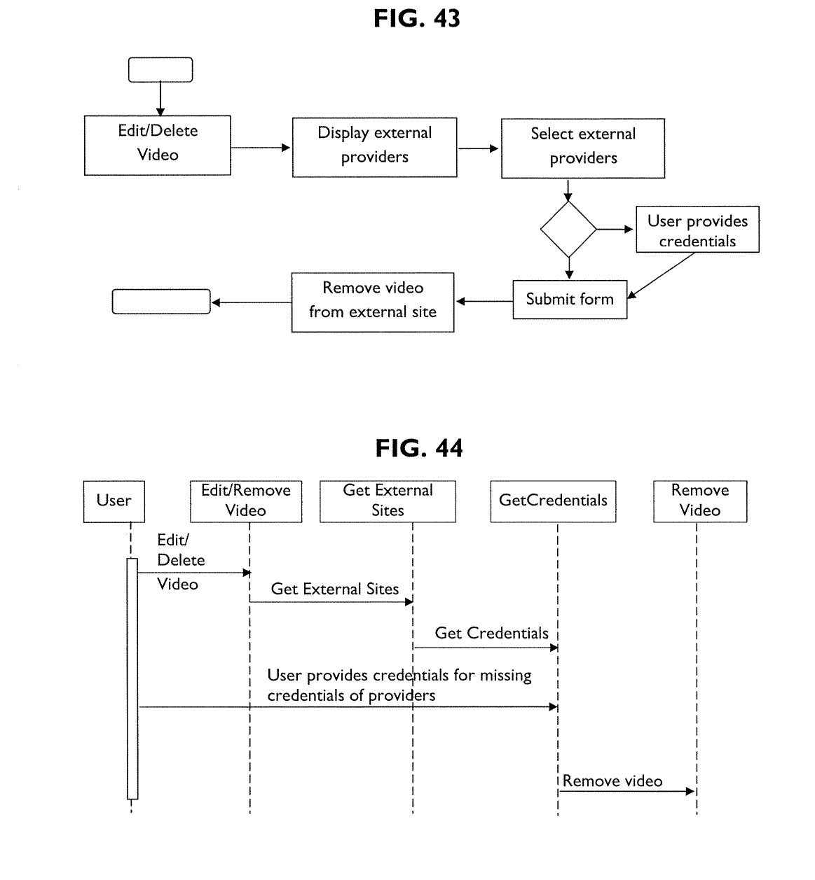

a. Activity Diagram. FIG. 43 is an activity diagram that illustrates the steps that system 100 and method 200 for distributing multimedia information performs when performing a post remove video process according to an embodiment of the present invention. The post remove activity begins when user selects the appropriate tabs as described supra, to remove one or more videos from one or more external providers 120. System 100 selects the external providers 120 to remove the video from, and provides user's 4 credentials to those external providers 120. User 4 then submits the appropriately completed form (in the form of a screenshot). System 100 then removes the one or more videos from each of the selected external providers 120. As those of ordinary skill in the art of the present invention can appreciate, the post remove video process describes an operation similar to that of uploading videos described supra in regard to user 4 and manage videos subsystem 18.

b. Sequence Diagram. FIG. 44 illustrates a sequence diagram representing several activities by the system and method for distributing multimedia information and authenticated users when performing the post remove video process as described in reference to FIG. 43 according to an embodiment of the present invention. The sequence of operations for performing the post remove video process according to an exemplary embodiment of the present invention begins with user 4 selecting the edit/delete video tab. Then, the edit/remove video sub-subsystem requests a list of external providers from the get external sites sub-subsystem. The get external sites sub-subsystem issues a request for credentials to the get credentials sub-subsystem. The get credentials sub-subsystem either provides previously stored credentials, or obtains them from user 4. The get credentials sub-subsystem then issues a remove videos command to the remove video sub-subsystem, which then forwards a remove video command to the one or more selected external sites 120.

### 3. Post Edit Video.

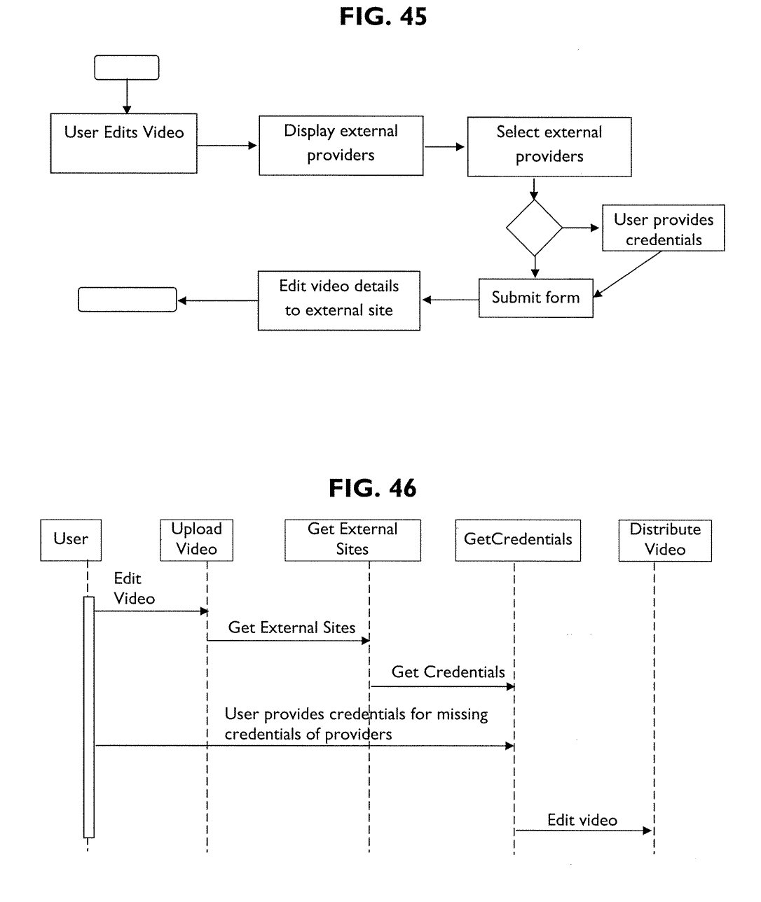

a. Activity Diagram. FIG. 45 is an activity diagram that illustrates the steps that the system and method for distributing multimedia information performs when performing a post edit video process according to an embodiment of the present invention. The post edit activity begins when user selects the appropriate tabs as described supra, to edit one or more videos at one or more external providers 120. System 100 displays a list of external providers 120, and user 4 selects the external providers 120 at which the videos will be edited, and provides user's 4 credentials to those external providers 120. User 4 then submits the appropriately completed form (in the form of a screenshot). System 100 then submits the edit video details to each of the selected external providers 120. As those of ordinary skill in the art of the present invention can appreciate, the post remove video process describes an operation similar to that of editing videos described supra in regard to user 4 and manage videos subsystem 18.

b. Sequence Diagram. FIG. 46 illustrates a sequence diagram representing several activities by the system and method for distributing multimedia information and authenticated users when performing the post edit video process as described in reference to FIG. 45 according to an embodiment of the present invention. The sequence of operations for performing the post edit video process according to an exemplary embodiment of the present invention begins with user 4 selecting the edit/delete video tab. Then, the upload video sub-subsystem requests a list of external providers from the get external sites sub-subsystem. The get external sites sub-subsystem issues a request for credentials to the get credentials sub-subsystem. The get credentials sub-subsystem either provides previously stored credentials, or obtains them from user 4. The get credentials sub-subsystem then issues an edit videos command to the distribute video sub-subsystem, which then forwards the edit video details to the one or more selected external sites 120.

### B. Additional Subsystems.

According to a preferred embodiment of the present invention, search subsystem 24 is software that searches external sites 120 for video using criteria supplied by user 4; database subsystem 26 is software that stores data utilized by system 100; and file subsystem 28 is software and hardware that manages access and storage of files.

### V. Additional Features of System 100 and Method 200.

According to additional exemplary embodiments of the present invention, additional features exist for use with system 100 and in accordance with method 200. As discussed above, users 4 can search for, or obtain from their own video storage locations and forward, additional videos. The additional videos can be sent to the user's 4 friends.

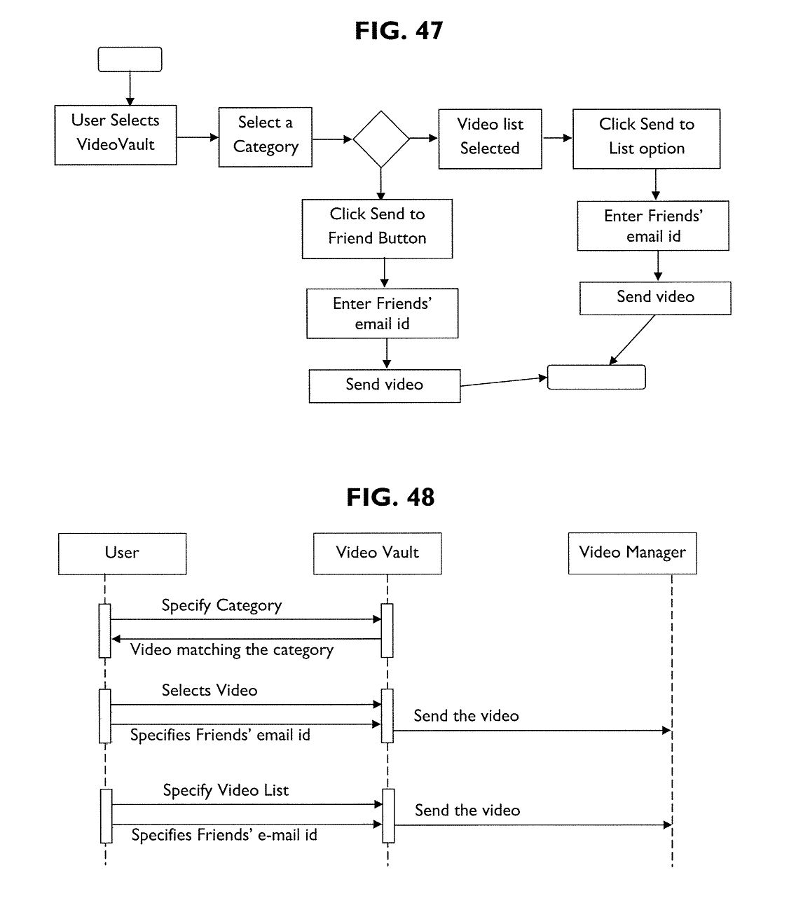

FIG. 47 is an activity diagram that illustrates the steps that system 100 and method 200 for distributing multimedia information performs when sending a video to a user's 4 friend according to an embodiment of the present invention. The activities that occur in regard to sending a video to a friend of user 4 will be discussed in the context of the remaining modes of operation shown in FIG. 16, which is the screen shot system 4 displays and user 4 encounters following successful login. According to a preferred embodiment of the present invention, there are at least two methods user 4 can send one or more videos to a friend (via email): following a video search and following a search or review of user's 4 videos in his or her own video vault. Each will be discussed briefly in turn, then the activity diagram of FIG. 47.

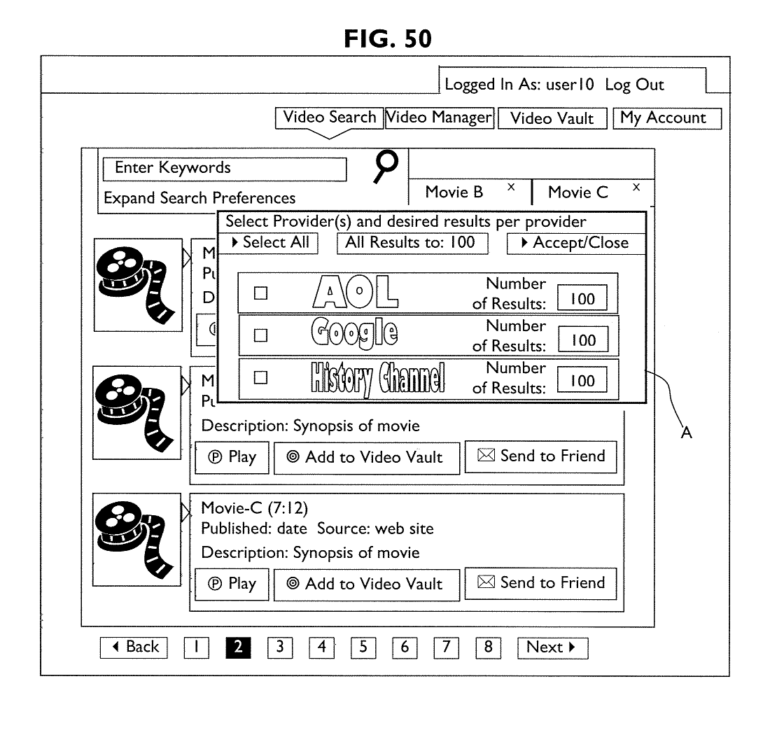

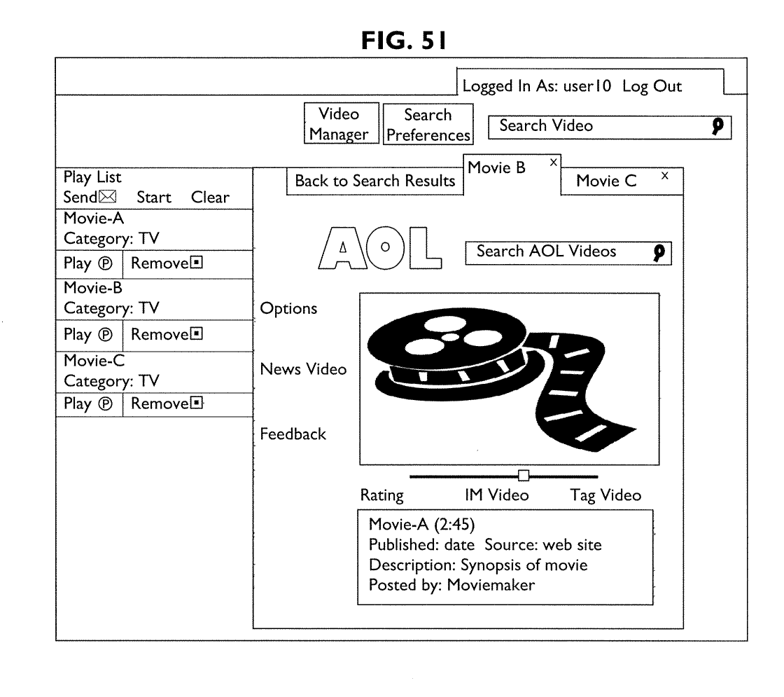

Referring to FIG. 16, user 4 can select video search as an operation to perform. After user 4 clicks on the video search tab, system 100 displays the screen shown in FIG. 49). User 4 can then enter search terms in the window that appears at the top of the screen. According to exemplary embodiments of the present invention, system, 100 can display user's 4 latest video uploads, among other items (as shown). Following the entering of search term or terms, user 4 clicks on the magnifying glass tab, signifying the search to begin, and system 4 begins a search of videos with metadata that contains one or more of the search terms provided by user 4. System 4 returns sub-window A as shown in FIG. 50. Sub-window A lists all the video providers with videos that have metadata that matches the search terms entered by user 4. User 4 can select individual videos to view, or a group from a provider, or to view all the videos provided by one or more providers. After user selects a video to view, FIG. 51 illustrates the selected video. User 4 can the forward the returned video by clicking on the “email this” tab, and enter the appropriate email address information of the friend. System 100 then forwards an email with the selected video clip to the friend of user 4.

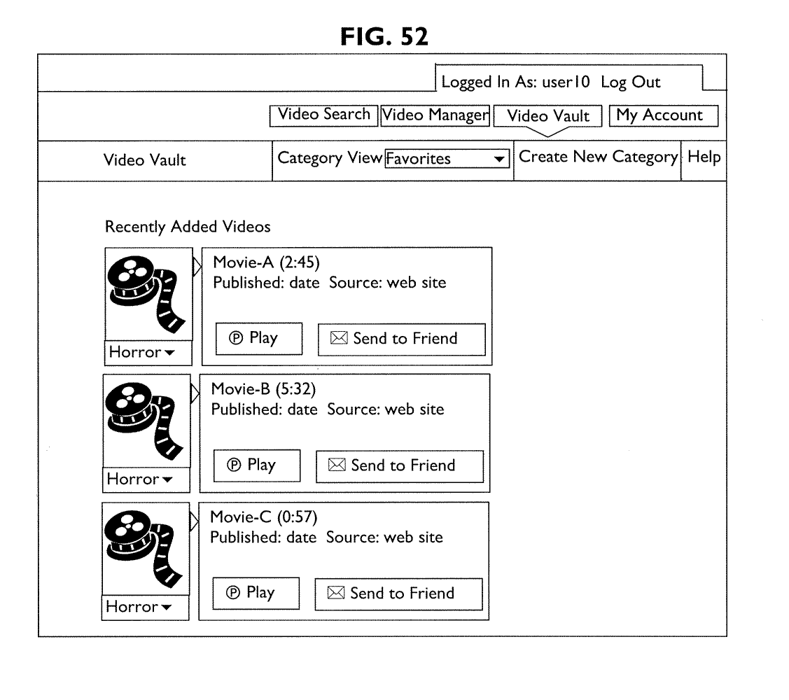

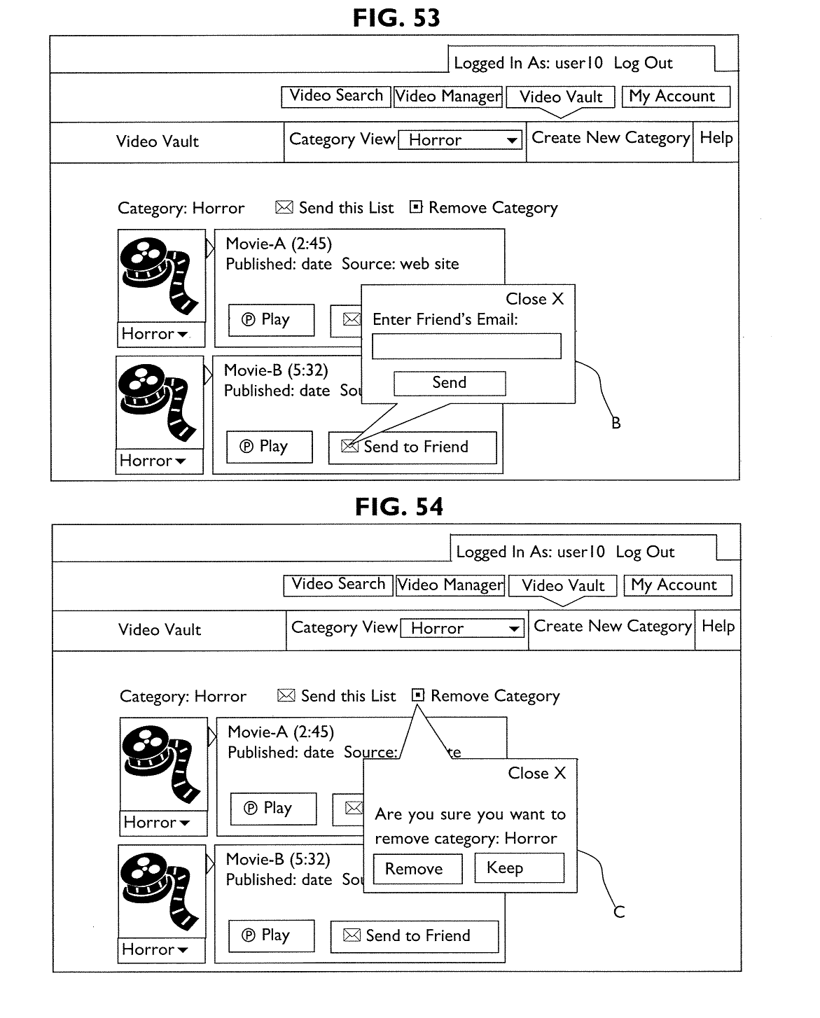

Referring again to FIG. 16, user 4 can select video vault as an operation to perform. After user 4 clicks on the video vault tab, system 100 displays FIG. 52. FIG. 52 illustrates a screen shot of a video vault page used by the system and method for distributing multimedia information according to an embodiment of the present invention. Located along a top upper bar is a category view window: according to an exemplary embodiment of the present invention system 4 displays an “All my Favorites” category of user 4; alternatively, there is a scroll down menu of all the categories of user's 4 videos. Whichever one user 4 selects will be displayed in the video display window as shown in FIG. 52. Still, according to a preferred embodiment of the present invention, user 4 can create a new category. The process for creating a new category has been described above and shall not be repeated again for purposes of clarity and brevity. System 100 lists one or more videos from the video vault of user 4, as seen on FIG. 52, there is a “play” and “send to friend” tab on each video listed. To send a video, user 4 clicks on the “send to friend” tab, and system 100 opens sub-window B, as shown in FIG. 53, which provides an email address entry screen for the video. Upon entry of the email address of the friend, user 4 clicks the “send” tab, and the video file is attached to an email and sent to the friend. In regard to creating and deleting categories of videos, as discussed supra, user 4 can delete categories of videos, and FIG. 54 shows a sub-window C that is opened when user 4 chooses to delete a category of video.

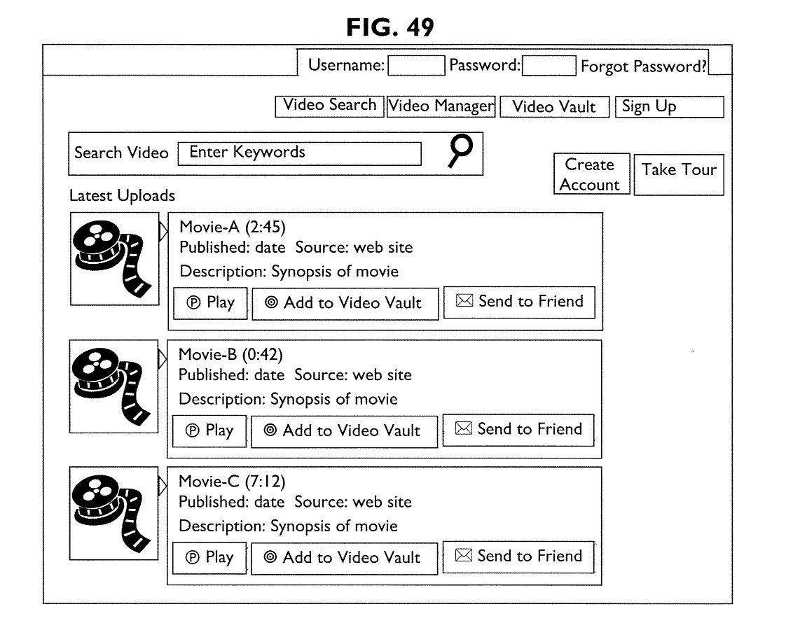

In context of the above discussion regarding the video search and video vault functions of the video manager subsystem, FIG. 47 is an activity diagram that illustrates the steps that system 100 and method 200 for distributing multimedia information performs when sending a video to a user's 4 friend according to an embodiment of the present invention, and FIG. 48 illustrates a sequence diagram representing several activities by the system and method for distributing multimedia information and authenticated users when sending the video to a user's friend as described in reference to FIG. 47 according to an embodiment of the present invention. Referring to FIG. 47, the activity begins when user 4 selects the video vault tab. System 100 then displays the video vault page, shown in FIG. 52, or the video search page, shown in FIG. 49. User 4 then selects a category in the category window located in both pages along an upper tool bar, and the video list of the entered category is displayed by system 100. If user 4 wants to send a displayed video, user 4 clicks on the “send to friend” button, enters the recipient's email address, and then clicks on the send button. In addition, user 4 can also send the returned and displayed list of videos of the provided category. After system 100 returns the list of selected videos that corresponds to the category provided by user 4, user 4 then clicks on the “send this list”, also located on an upper tool bar of both the video vault search results returned page (FIG. 53), and the video search returned results page (FIG. 50). User 4 then enters the friend's emails address and clicks on the send button.

Referring now to FIG. 48, which illustrates a sequence diagram representing several activities by system 100 and method 200 for distributing multimedia information when sending video to a user's 4 friend as described in reference to FIG. 47 according to an embodiment of the present invention. The sequence represented by FIG. 48 begins with user 4 specifying a category of videos to search to the video vault module. The video vault module returns videos that match the provided category. User 4 then selects the video to send to a friend, and provides the choice to the video vault module. Furthermore, user 4 also provides an email address to the video vault module.

### VI. Architecture of System and Method for Distributing Multimedia Information

A. Introduction. According to an exemplary embodiment of the present invention, a commercially viable embodiment of the present invention is referred to as “VideoKeyHole.com”. The exemplary embodiments described above, and further defined below, provide the ability to link users 4 to video (including, by means of non limiting examples, TV shows, movies, and all sorts of other video content provided by sources such as Google, AOL.COM/IN2TC, I-Film and others). In addition users 4 can upload their own videos into multiple sources from a single point.

According to exemplary embodiments of the present invention, system 100 and method 200 provide a search page to user 4 where he or she can search movies, and/or videos. User 4 will also be given a list of search engines to choose from. According to a preferred embodiment of the present invention, as described above, in reference to FIG. 50, for example, user 4 can specify multiple search engines in one search. The search results will be aggregate of the results from the search engines specified by the users.

A flow diagram that illustrates process flow, as well as several block diagrams that illustrates architecture are discussed in detail below. Through use of such process flow and architecture, users 4 can upload their videos to system 100 which in turn submits the videos to multiple sources (as pre-selected by user 4) for which user 4 has provided details for the account.

By way of efficient software module and architecture design, the exemplary embodiments of the present invention provide one or more of the following advantages: minimal response time; simultaneous processing of search results from different search engines (according to a preferred embodiment of the present invention, the search results will be retrieved in xml format); aggregating the results retrieved from the one or more search engines; maintaining a catalog of key word for which search results have been acquired; periodically updating the search results; and single point for uploading to multiple sources.

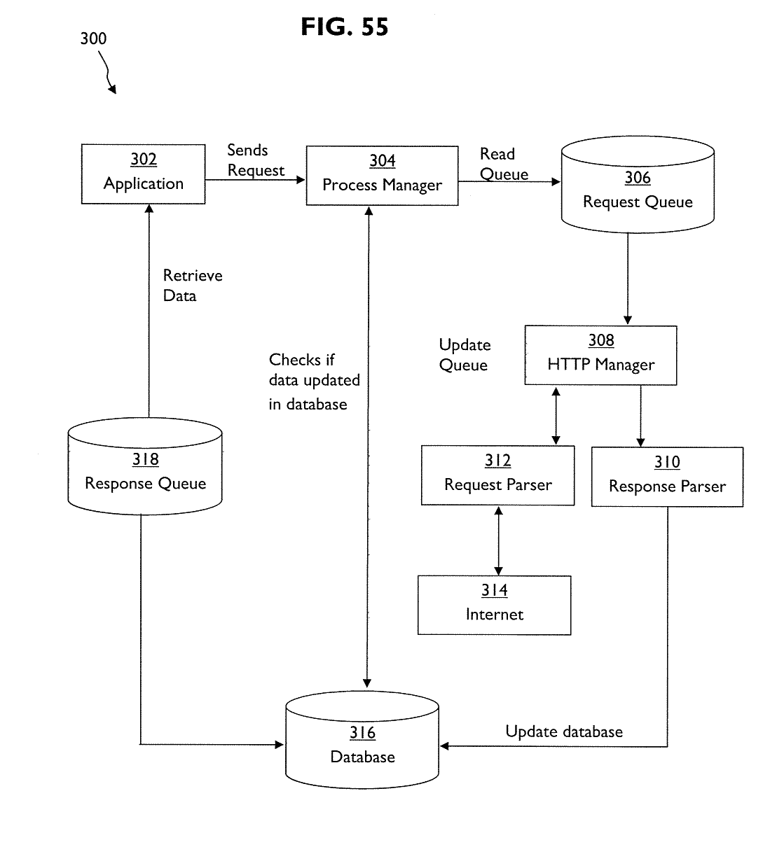

The architecture, which is shown and defined in FIGS. 55-58, comprises three main elements defined as follows: (1) one or more .aspx pages will utilize ajax techniques to make the request for the videos as well as to display the same; (2) once the request is made for the keyword from the respective search engines, the control will be transferred to the search service which will interact with the external search engines selected, retrieve the data and update database 14 with the relevant records; and (3) after the records have been updated in database 14, the same will be displayed on the .aspx page.

FIG. 55 illustrates a block diagram of an architecture of a system 100 for distributing multimedia information in accordance with an exemplary embodiment of the present invention. Architecture 300 comprises an application 302, which comprises the .aspx page as well as other required items, and will utilize asynchronous ajax to make the asynchronous call for the request, as well as to populate the page with the data retrieved from database 14, and process manager 304 which manages the client-request made by a user and is responsible for creating the request and response queues for each client-request. Process manager 304 will also ensure that requests are handed over correctly to a request parser. Process manager 304 will also receive the data from the response parser and update database 14 as well as update the status of the request on the response queue about the updating of database 14.

Architecture 300 further comprises request queue 306, and response queue 318. The two queues 306, 318 can be implemented in the form of two separate entities, or, conversely, can be implemented in one entity. According to an exemplary embodiment of the preset invention, the application will be responsible for putting the requests in request queue 306 and extracting as well as deleting the response from response queue 318. Furthermore, response queue 318 can contain the status of the requests in process and can further provide the same when queried by the application for a specific request.

Architecture 300 further comprises http manager 308. Http manager 308 can be the communication link between process manager 304 and the external internet environment 314. Http manager 308 can further be responsible, according to an exemplary embodiment of the present invention, for encrypting and dispatching requests to individual web sites as well as receiving responses, decrypting them, and sending the decrypted responses to the response parser 310.

Request parser 312, which is also part of architecture 300, can be mainly responsible for parsing the request data in the format required by http manager 308. Architecture 300 further comprises response parser 310, which parses the data from http manager 308 to the format required by process manager 304.

In some embodiments, there may be provided an upload manager. The upload manager may be part of the process manager 304. The upload manager provides an interface for authenticating and uploading of user vides to external websites using HTTP Protocol. In other embodiments, there may also be provided a user manager. User manager services the user registration, authentication and playlist management. In still other embodiments, there may also be provided a refresher service to periodically check if parsers are able to process data from the external sources. Refresher service is a windows service which scans through all the available parsers for the providers with a given keyword at periodic intervals. In case the results are not fetched, this service would mark the engine as inactive. This service will also refresh most recent and actively used cached data.

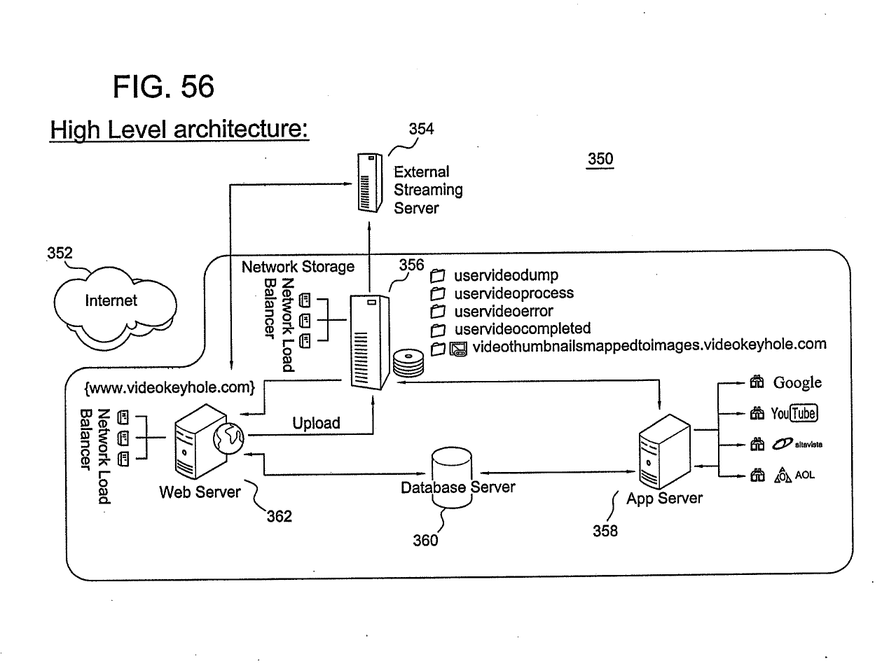

FIG. 56 illustrates a block diagram of a high level architecture 350 of system 100 and method 200 for distributing multimedia information according to an embodiment of the present invention. High level architecture 350 includes internet 352 through which users 4 gain access to system 100 and method 200 for distributing multimedia information according to exemplary embodiments of the present invention. High level architecture 350 further includes external streaming server 354, web server 362, database server 360 (wherein database 14 can be preferably located), and application server 358. Application server 358 has connectivity to various multimedia storage facilities, such as Google, YouTube, altavista, and AOL, among others. High level architecture still further includes network storage 356 and a network load balancer. As those of ordinary skill in the art of the present invention can appreciate, the particular configuration of components in high level architecture 350 can be changed, or altered, to include substantially similar or different components, in a substantially identical or different configuration, and yet method 200 can still provide substantially identical functionality for users 4 for searching, storing uploading and distributing multimedia, as described herein. Those of ordinary skill in the art of the present invention can appreciate the operations of the various components and so each shall not be described again for purposes of clarity and brevity.

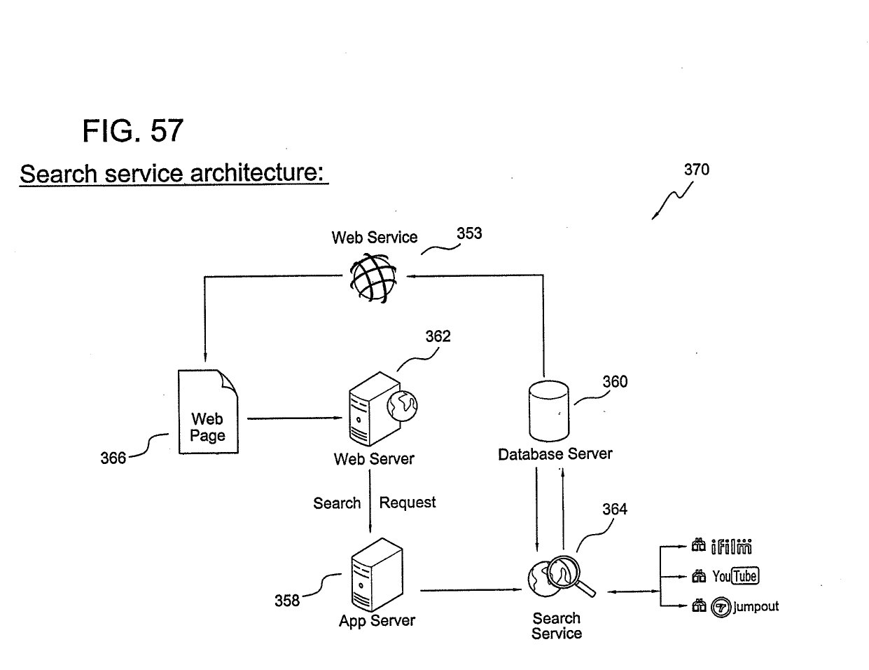

FIG. 57 illustrates a block diagram of a search service architecture 370 of system 100 and method 200 for distributing multimedia information according to an embodiment of the present invention. Search service architecture 370 includes web page 366, web server 362, application server 358, search service 364 (which connects and accesses multimedia storage facilities such as ifilm, YouTube, and jumpout, among others), database server 360, and web service 353. As those of ordinary skill in the art of the present invention can appreciate, the particular configuration of components in search service architecture 370 can be changed, or altered, to include substantially similar or different components, in a substantially identical or different configuration, and yet method 200 can still provide substantially identical functionality for users 4 for searching, storing uploading and distributing multimedia, as described herein.

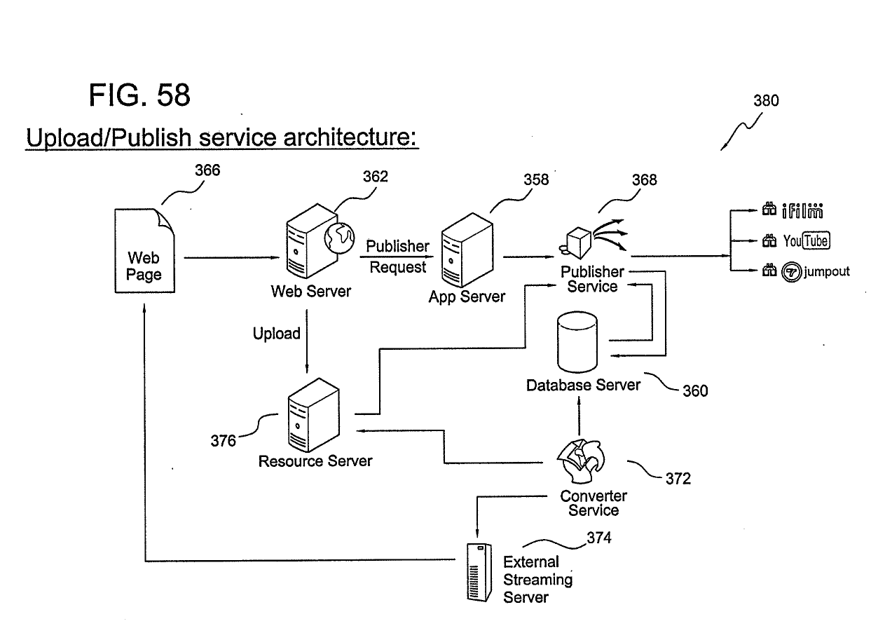

FIG. 58 illustrates a block diagram of an upload/publish service architecture 380 of system 100 and method 200 for distributing multimedia information according to an embodiment of the present invention. Upload/publish service architecture 380 includes web page 366, web server 362, application server 358, publisher service 368 (which connects and accesses multimedia storage facilities such as ifilm, YouTube, and jumpout, among others), database server 360, resource server 376, converter service 372, and external streaming server 374. As those of ordinary skill in the art of the present invention can appreciate, the particular configuration of components in upload/publish architecture 380 can be changed, or altered, to include substantially similar or different components, in a substantially identical or different configuration, and yet method 200 can still provide substantially identical functionality for users 4 for searching, storing uploading and distributing multimedia, as described herein.

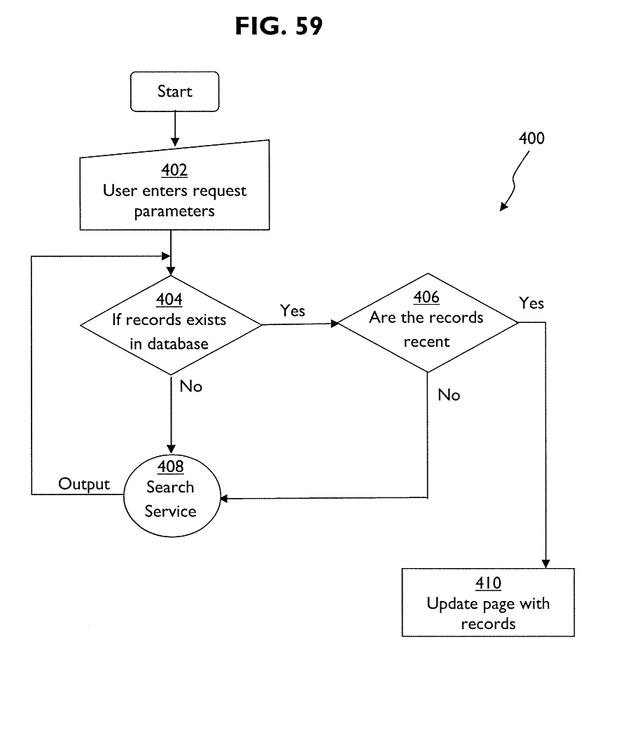

FIG. 59 illustrates application flow chart 400 of system 100 and method 200 for distributing multimedia information according to an embodiment of the present invention. Application flowchart (method) 400 describes an overall process for using system 100 from a system standpoint according to a preferred embodiment of the present invention. Application method 400 begins with step 402 wherein user 4 enters request parameters. The request parameters are used by user 4 to find particular multimedia data, or multimedia storage services. In decision step 404, application method 400 determines if one or more records exist in database 14; if one or more records do exist (“Yes” path from decision step 404), method 400 proceeds to decision step 406. If no records exist (“No” path from decision step 404), then method 400 proceeds to step 408, wherein control is transferred to search service (embodied in search service architecture 370). The output of executing the search service returns method 400 to decision step 404. In decision step 406, method 400 determines if the records are recent (the definition of whether something is recent or not can be changed, from time to time, or it can remain constant. For example, “recent” can be 45 days, or start at 45, and then depending on how often records are updated and/or changed, that number can rise or fall). If the records are not recent (“No” path from decision step 406), then method 400 proceeds to step 408, search service. The output of executing the search service returns method 400 to decision step 404. If the records are recent (“Yes” path from decision step 406), then method 400 updates the web page (i.e., the applicable screen shot), with the relevant records for user 4 to view and act upon if desired.

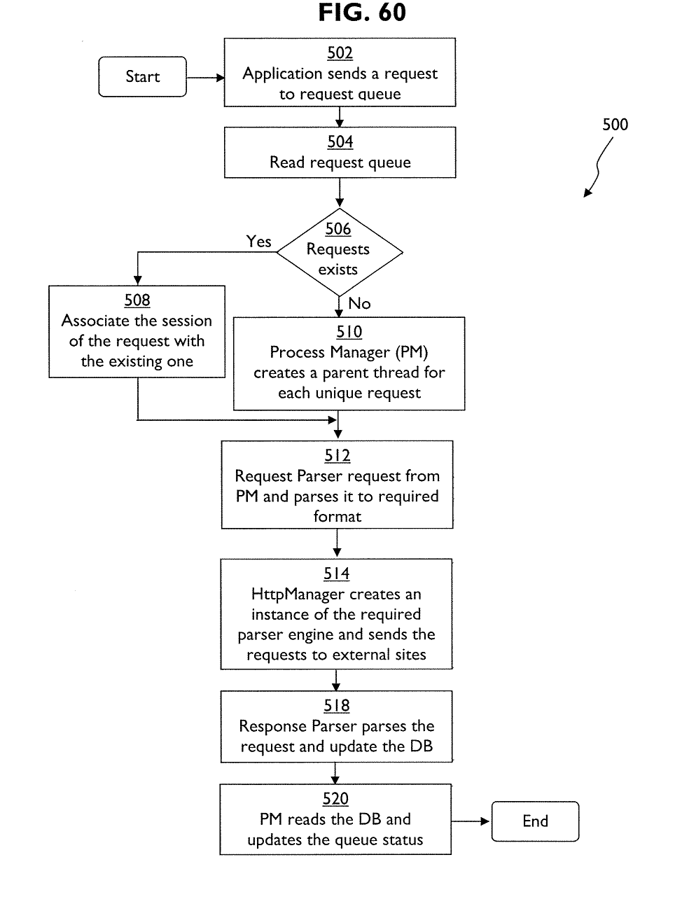

FIG. 60 illustrates search service flowchart 500 of system 100 and method 200 for distributing multimedia information according to an embodiment of the present invention. As discussed in reference to FIG. 59, if no records exist in database 14, or if the records are not recent, then method 400 transfer control to search service operation 500. Search service 500 accesses external sites to obtain the desired information about the multimedia or multimedia storage sites. FIG. 60 illustrates the steps of method 500 for executing search service in accordance with a preferred embodiment of the present invention. Search service method (method) 500 begins with step 502 in which application server 358 sends a request to request queue 306. Application server 358 reads the request queue output in step 504, and then method 500 proceeds to decision step 506, wherein method 500 determines whether a request exists: If no request exists (“No” path from decision step 506), then method 500 proceeds to step 510. In step 510, process manager 304 creates a parent thread for each unique request. If the request exists (“Yes” path from decision step 506), then method 500 proceeds to step 508.

In step 508, method 500 associates the session of the request with the existing one (already existing request). following steps 508 or 510, method 500 proceeds to step 512. In step 512, request parser 312 obtains the request from process manager 304 and parses it into the required format. In step 514, HTTP manager 308 creates an instance of the required parser engine and send the request to one or more external sites. In step 515, HTTP manager 308 receives data from external sites in accordance with the transmitted request. In step 518, response parser 310 parses the request and updates database 14 (part of database 316). In step 520, process manager 304 reads database 14/316 and updates the queue status.

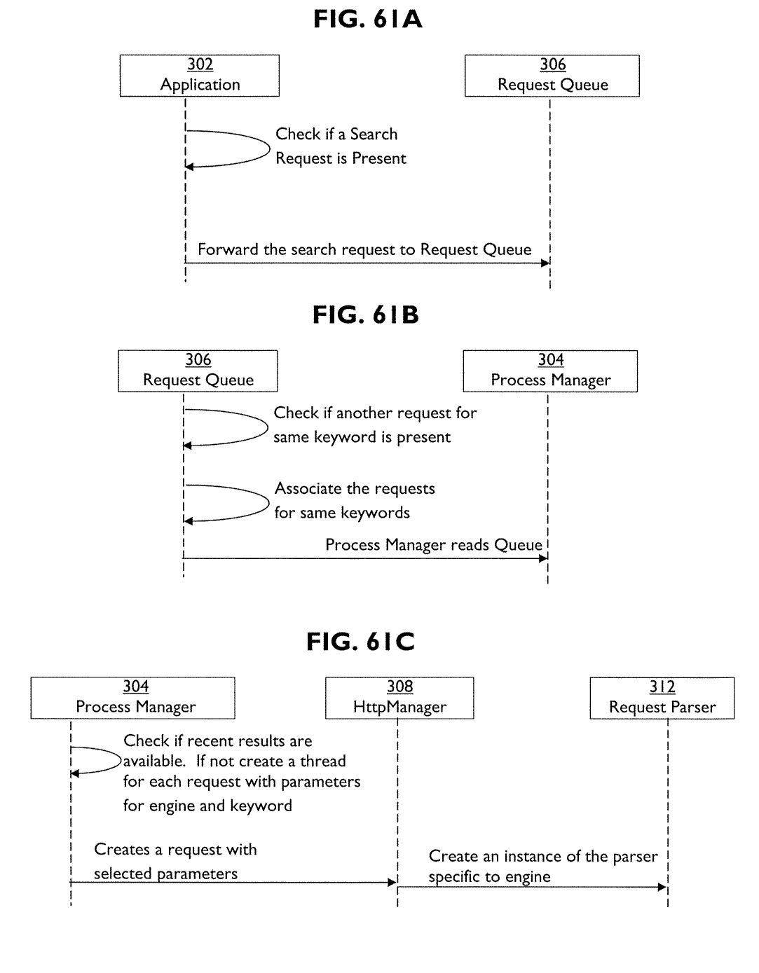

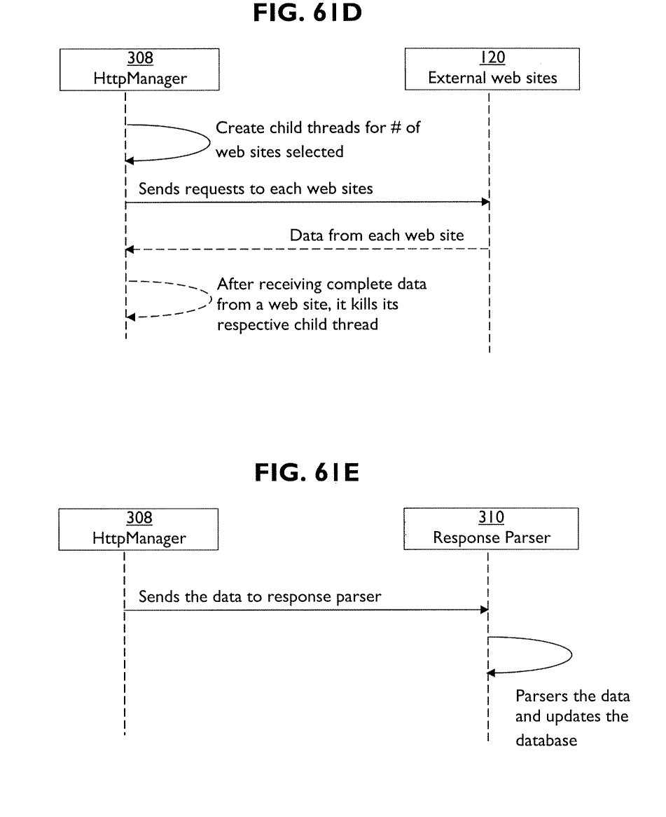

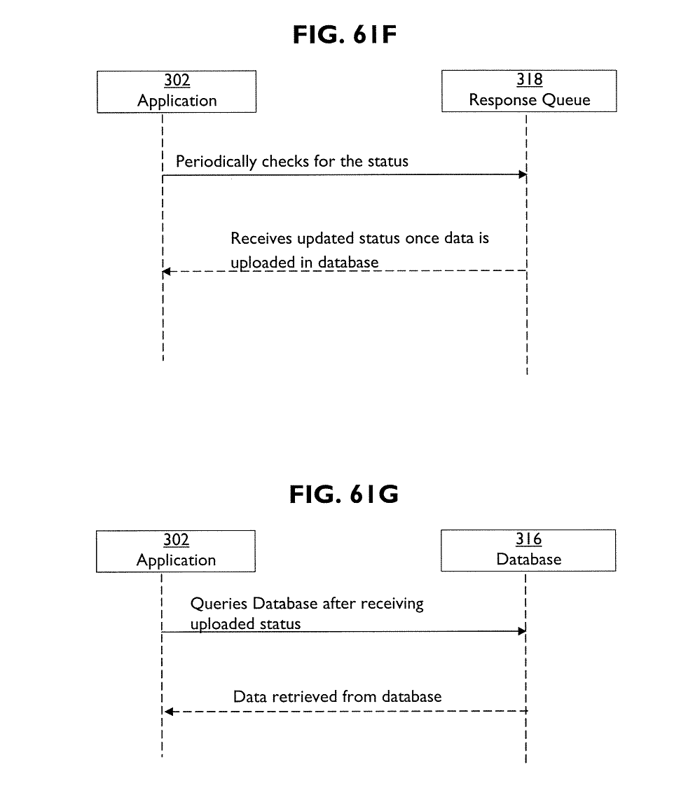

The present invention will now be described in the following exemplary embodiment in FIGS. 61A-61G. FIG. 61A is a sequence diagram illustrating various steps in performing a check/retrieve search queue from database 316 used in system 100 and method 200 for distributing multimedia information according to an embodiment of the present invention. The sequence of events for determining whether a search queue exists begins when user 4 searches for one or more keywords in the application. Application 302 logs the request in database 316. Application 302 then queries database 316 to determine if a search request is present. If a search request is present, the request will be forwarded to request queue 306 for further processing.

FIG. 61B is a sequence diagram illustrating various steps in sending a request to process manager 304 as used in system 100 and method 200 for distributing multimedia information according to an embodiment of the present invention. In FIG. 61B request queue 306 is processed by a request handler to determine if there is more than one request for the same keyword. When more than one requests exists, all the remaining requests will be associated with the one in request queue and transmitted to process manager 304. This action substantially prevents multiple searches for the same keyword at the same instance. Request handler transmits request queue 306 to process manager 304 when there is only one request for the same keyword. Process manager 304 reads the request from the request queue 306 and generates a parent thread to accompany it.

FIG. 61C is a sequence diagram illustrating various steps in parsing request data and sending it to an HTTP manager used in the system and method for distributing multimedia information according to an embodiment of the present invention. Process manager 304 first determines if any recent results are available to satisfy request queue 306. When there are no recent results, a parent thread is created for each request. The parent is associated with the keyword and the engine sites selected. If a recent request is present, process manager 304 does not add the engine sites selection to the parent thread. HTTP manager 308 receives the parent thread and creates an instance of the parser specific to each engine site. Requesting parser 312 reads the HTML from the external site and sends the information back to HTTP manager 308.

FIG. 61D is a sequence diagram illustrating various steps in creating multiple requests and receiving data from external web sites used in the system and method for distributing multimedia information according to an embodiment of the present invention. When process manager 304 sends multiple requests to HTTP manager 308, HTTP manager 308 creates child threads based on the keywords to search each engine site 120. Each child thread is a new request for each of the specific engine sites 120 to search for the keyword in the child thread. Upon receiving data, such as the top results, the child thread is terminated. HTTP manager 308 sends the top results to a response parser 310 in FIG. 61E.

FIG. 61E is a sequence diagram illustrating various steps in which a response parser parses data and updates a database used in the system and method for distributing multimedia information according to an embodiment of the present invention. Response parser 310 parses the top results and updates database 316. After updating database 316, HTTP manager 310 updates the status of the response queue 318.

FIG. 61F is a sequence diagram illustrating various steps in which an application checks a status of a request as used in the system and method for distributing multimedia information according to an embodiment of the present invention. Application 302 periodically checks the status of response queue 318 by making an (asynchronous javascript and xml) ajax call. Once response queue 318 indicates the data is updated in database 316, application 302 will receive the update status.

FIG. 61G is a sequence diagram illustrating various steps in retrieving data from a database as used in the system and method for distributing multimedia information according to an embodiment of the present invention. Prior to retrieving data from database 316, application 302 receive an indication of a status update. Next application 302 queries database 316 to send the data. Once all data is transferred to application 302, application deletes the entry in the response queue 318.

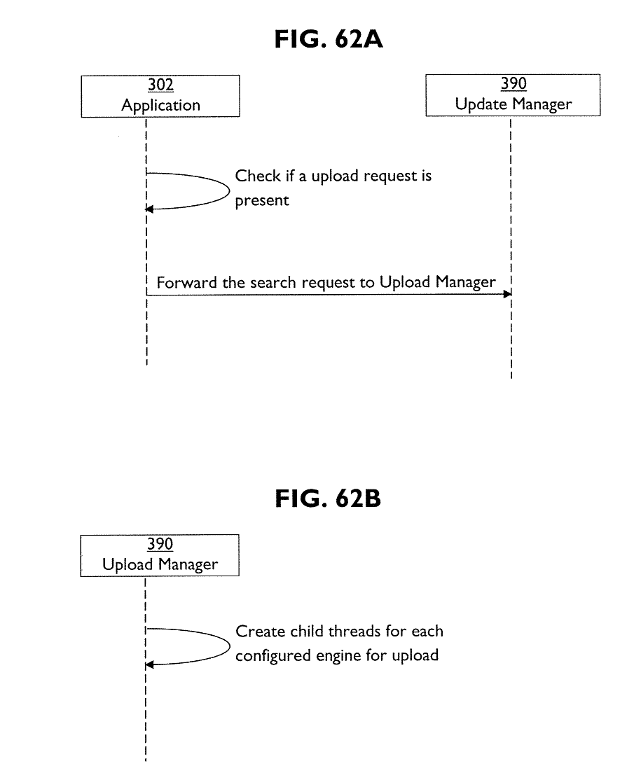

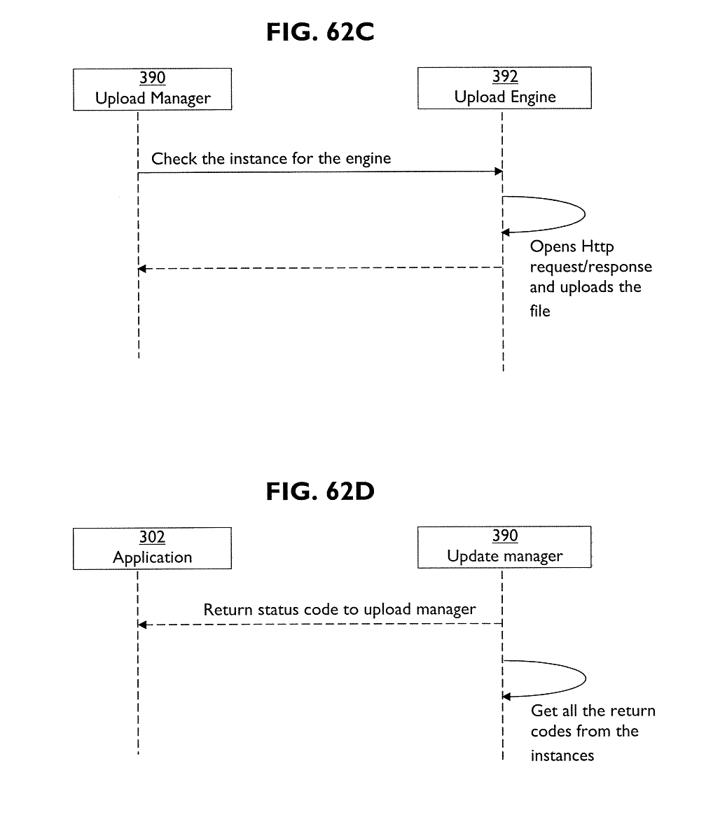

An exemplary embodiment of uploading video data according to the present invention will now be described in FIGS. 62A-62D. FIG. 62A is a sequence diagram illustrating various steps in which an upload process checks/retrieves an uploads queue used in the system and method for distributing multimedia information according to an embodiment of the present invention. In FIG. 62A, application 302 sends a video file for upload across multiple providers and logs the upload in the database 316. Application 302 queries database 316 to determine if an upload request is present. When present, application 302 transmits the request to an upload manager 390.

FIG. 62B is a sequence diagram illustrating various steps in performing an upload to the system and method for distributing multimedia information according to an embodiment of the present invention. Upload manager 390 creates threads for each instance of the engine site to be upload with the video.

FIG. 62C is a sequence diagram illustrating various steps in which an upload manager creates instances of upload engines as used in the system and method for distributing multimedia information according to an embodiment of the present invention. Upload manager 390 sends the instance to each upload engine 390 using HTTP protocols. Upload engine 392 opens the request and loads the file. Once completed a status code is sent from upload engine 392 to upload manager 390.

FIG. 62D is a sequence diagram illustrating various steps in which an upload manager updates a status of an upload as used in the system and method for distributing multimedia information according to an embodiment of the present invention. Upload manager 390 gets all the return status codes from the instances and returns those status codes from upload engines 392 to application 302.

Exemplary embodiments of the present invention can also incorporate one or more the following services. Search service is a windows service that queries the database at regular interval to get the pending search requests. If any pending search request is retrieved, it forwards the request to the request queue for further processing. Upload service is a windows service that queries the database at regular interval to get the pending upload requests. If any pending search upload is retrieved, it forwards the request to the upload manager for further processing. Convert videos-to-flash is a windows service that continuously monitors the directory where the videos are dumped after upload. The service converts the newly uploaded videos to .flv format and uploads it to external streaming server. Search web service is a web service that returns the search results of the videos uploaded to a central web site operating embodiments of the present invention. Delete old records service is a windows services that executes at definite periods (normally once a day, but can be configured). It deletes all the search records from the database that are outdated.

As users 4 are not expected to scan through all the retrieved search results, the request parser can only fetch limited results that would be configured per engine. In case user 4 specifically navigates to more results, the request parser can fetch the reminder of the results. The results can be cached per search engine per keyword based on a weight. The keyword weight can be derived from the traffic based on the keyword as well as the type of engine.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents and applications, and publications discussed above are hereby incorporated by reference herein in their entireties.

What is claimed is:

1. A system for distributing multimedia information, comprising:
a user interface module,
wherein the user interface module is configured to receive an upload of multimedia information from a user; and
wherein the user interface module is configured to receive at least one multimedia information distribution indication from the user for selecting at least one remote site to which to distribute the multimedia information; and
a multimedia information distribution module in communication with the user interface module,
wherein the multimedia information distribution module is configured to distribute the multimedia information to the at least one remote site in accordance with the multimedia information distribution indication.

2. The system according to claim 1, further comprising:
a multimedia information search module in communication with the multimedia information management module.

3. The system according to claim 2, wherein the multimedia information search module is configured to search for multimedia information uploaded by the user.

4. The system according to claim 2, wherein the multimedia information search module is configured to search for multimedia information located on the at least one remote site.

5. The system according to claim 1, further comprising:
a multimedia information management module in communication with the multimedia information distribution module,
wherein the multimedia information management module is configured manage the multimedia information and multimedia characteristic information associated with the multimedia information.

6. The system according to claim 1, further comprising:
a database module in communication with the multimedia information distribution module,
wherein the database module is configured to store at least one of the multimedia information and user characteristic information.

7. The system according to claim 1, wherein the multimedia information comprises video multimedia information.

8. The system according to claim 1, wherein the multimedia information comprises audio multimedia information.

9. The system according to claim 1, wherein the multimedia information comprises photographic multimedia information.

10. The system according to claim 1, wherein the multimedia information distribution module is configured to interface to the at least one remote site.

11. The system according to claim 1, wherein the multimedia information distribution module is configured to edit multimedia information in accordance with commands received from the user via the user interface module.

12. The system according to claim 1, wherein the multimedia information distribution module is configured to edit multimedia characteristic information in accordance with commands received from the user via the user interface module.

13. The system according to claim 1, wherein the multimedia information distribution module is configured to delete multimedia information from the at least one remote site in accordance with instructions received from the user via the user interface module.

14. The system according to claim 1, wherein the user interface module is configured to display a graphical user interface to the user for interacting with the system.

15. The system according to claim 1, wherein the multimedia information distribution module comprises:
a communication module,
wherein the communication module is configured to communicate information between the system and the at least one remote site.

16. A system for distributing multimedia information, comprising:
a system access engine,
wherein the system access engine is configured to display a graphical user interface to the user for interacting with the system,
wherein the system access engine is configured to receive an upload of multimedia information from a user; and
wherein the system access engine is configured to receive a plurality of multimedia information distribution selections from the user for selecting a plurality of remote sites to which to distribute the multimedia information; and
a distribution engine in communication with the system access engine,
wherein the distribution engine is configured to distribute the multimedia information to the plurality of remote sites in accordance with the multimedia information distribution selections.

17. A method for distributing multimedia information, comprising:
a.) receiving an upload of multimedia information from a user;
b.) receiving at least one multimedia information distribution indication from the user to select at least one remote site to which to distribute the multimedia information; and
c.) distributing the multimedia information to the at least one remote site in accordance with the multimedia information distribution indication.

18. A computer-readable medium containing a computer program for distributing multimedia information, wherein the computer program performs the steps of:
a.) receiving a first indication of an upload of multimedia information from a user;
b.) receiving a second indication of least one multimedia information distribution selection from the user to select at least one remote site to which to distribute the multimedia information; and
c.) generating a signal to cause a distribution of the multimedia information to the at least one remote site in accordance with the multimedia information distribution indication.

19. A system for distributing multimedia information, comprising:
means for displaying multimedia information,
wherein the multimedia information displaying means is configured to receive an upload of multimedia information from a user; and
wherein the multimedia information displaying means is configured to receive at least one multimedia information distribution indication from the user for selecting at least one remote site to which to distribute the multimedia information; and
means for distributing multimedia information in communication with the multimedia information displaying module,
wherein the multimedia information distributing means is configured to distribute the multimedia information to the at least one remote site in accordance with the multimedia information distribution indication.
